(19) United States
(12) Patent Application Publication
(10) Pub. No.: US 2013/0070925 A1
(43) Pub. Date: Mar. 21, 2013

(54) COMMUNICATION DEVICE, RECORDING MEDIUM, AND METHOD THEREOF

(71) Applicants: Kenji Yamada, Ooonojou (JP); Tadashige Iwao, Kawasaki (JP); Hidefumi Takaoka, Fukuoka (JP); Syunsuke Koga, Fukuoka (JP); Tetsuya Izu, Ichikawa (JP); Masahiko Takenaka, Kawasaki (JP)

(72) Inventors: Kenji Yamada, Ooonojou (JP); Tadashige Iwao, Kawasaki (JP); Hidefumi Takaoka, Fukuoka (JP); Syunsuke Koga, Fukuoka (JP); Tetsuya Izu, Ichikawa (JP); Masahiko Takenaka, Kawasaki (JP)

(73) Assignee: FUJITSU LIMITED, Kawasaki-shi (JP)

(21) Appl. No.: 13/613,633

(22) Filed: Sep. 13, 2012

Related U.S. Application Data
(63) Continuation of application No. PCT/JP2010/001912, filed on Mar. 17, 2010.

(51) Int. Cl. H04L 9/08

(52) U.S. Cl. CPC H04L 9/08
USPC 380/255

(57) ABSTRACT

A communication device includes a data storage unit, a decryption unit, an encryption unit, and a judgment unit. The data storage unit stores a piece of encrypted data or a piece of decrypted data. The decryption unit decrypts each provided piece of encrypted data. The encryption unit encrypts each provided piece of decrypted data. The judgment unit issues an instruction to the encryption unit to read from the data storage unit first decrypted data obtained by the decryption unit decrypting first encrypted data with a cryptographic key, and to write back to the data storage unit second encrypted data obtained by the encryption unit encrypting the first decrypted data with the cryptographic key.

### CROSS-REFERENCE TO RELATED APPLICATION

This application is a continuation of International Application PCT/JP2010/001912 filed on Mar. 17, 2010 and designated the U.S., the entire contents of which are incorporated herein by reference.

### FIELD

The embodiments discussed herein are related to encrypted communications.

### BACKGROUND

One of the current topics relating to encrypted communications by symmetric cryptography is key establishment between a transmitter and a receiver.

For example, in a first node device in the network configured by a plurality of node devices, an access key generation unit changes a first access key as a cryptographic key inherent to the first node device for each first time period. Then, a shared key generation unit changes a shared key shared among the plurality of node devices for each second time period.

In addition, the first node device encrypts the generated first access key with the generated shared key and transmits the encrypted key, and receives an access key notification frame including the data obtained by encrypting a second access key of a second node device with the shared key and transmitted from the second node device. In the first node device, a decryption unit decrypts the received access key notification frame using the generated shared key, thereby acquiring a second access key. Furthermore, a transmitter of the first node device transmits an encrypted frame obtained by encrypting with the second access key a plaintext frame provided with signature data obtained by encrypting the data including a hash value calculated from the plaintext frame with the shared key.

A security architecture for Internet protocol (IPsec) is also known as an architecture for a secure communication, and an encrypted communication system using the IPsec is also know. For example, the following encrypted communication system including the monitor control server for distributing a cryptographic key corresponding to a virtual local area network (VLAN) to an IPsec gateway to which one or more terminals is proposed.

That is, the monitor control server includes a device for managing and distributing a cryptographic key corresponding to the VLAN to be distributed to the IPsec gateway. Then, the IPsec gateway includes new key memory for holding a cryptographic key newly distributed by the monitor control server as a new key and old key memory for holding a previously distributed cryptographic key as an old key. The IPsec gateway further includes a device for switching to an encrypted communication using an old key held in the old key memory when an encrypted communication using a new key fails.

Additionally, a key synchronization mechanism of a wireless local area network (LAN) has been proposed. In the key synchronization mechanism, an access point does not start using a new encrypted cryptographic key until the first data frame is received from a station. The new key is used until a key refresh interval expires.

In the encrypted communication system in which a cryptographic key is updated, the following problem may be generated by the shift between the timing with which ciphertext data is transmitted and the timing with which a cryptographic key is established between a transmission device and a reception device. That is, there may be a case in which decryption with the latest cryptographic key, which is recognized by the reception device as a cryptographic key to be used for decryption, fails to correctly decrypt data.

For example, at a point in time when the transmission device has not yet update a cryptographic key (i.e., immediately before the reception device updates the cryptographic key), the transmission device may generate ciphertext data by encrypting data using the cryptographic key before update and may transmit the generated ciphertext data. Then, the reception device may update the cryptographic key immediately before receiving the ciphertext data. Then, the reception device fails to correctly decrypt the received ciphertext data using the cryptographic key after update as currently recognized as a cryptographic key for decryption.

Then, it is preferable that the reception device performs any process for obtaining correct plaintext data. For example, the reception device holds not only the latest cryptographic key but also an old cryptographic key, and if the device fails in decryption using the latest cryptographic key, it may decrypt again the ciphertext data using the old cryptographic key. Then, the reception device may obtain correct plaintext data although it receives the ciphertext data encrypted using the old cryptographic key before update.

To be more concrete, when the reception device receives ciphertext data, the reception device may perform the following operation. That is, the reception device decrypts data using the latest cryptographic key, and continues holding the ciphertext data after the decryption for the re-decryption to be performed using the old cryptographic key. Then, the reception device verifies the decrypted data. The reception device decrypts the ciphertext data using the old cryptographic key if correct plaintext data is not obtained by the decryption.

Also known are the documents such as International Publication Pamphlet No. WO2009/130917, Japanese Laid-open Patent Publication No. 2007-267301, Japanese National Publication of International Patent Application No. 2007-500972, etc.

### SUMMARY

According to an aspect of the embodiments, a communication device includes a data storage unit, a decryption unit, an encryption unit, and a judgment unit.

The data storage unit stores a piece of encrypted data or a piece of decrypted data. The decryption unit decrypts each provided piece of encrypted data. The encryption unit encrypts each provided piece of decrypted data.

The judgment unit issues an instruction to the encryption unit to read from the data storage unit first decrypted data obtained by the decryption unit decrypting first encrypted data with a cryptographic key, and to write back to the data storage unit second encrypted data obtained by the encryption unit encrypting the first decrypted data with the cryptographic key.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a timing chart of an example of a communication according to a first embodiment;

FIG. 2 is a system configuration of an example of an environment according to the first embodiment;

FIG. 3 is a block diagram of the configuration of the communication device according to the first embodiment;

FIG. 4 is an example of a configuration of the hardware of the communication device according to the first embodiment;

FIG. 5 is an example of the data stored in the communication device according to the first embodiment;

FIG. 6 is an explanatory view of the format of the data transmitted and received according to the first embodiment;

FIG. 7 is a flowchart of the receiving process performed when the communication device according to the first embodiment receives data;

FIG. 8 is an explanatory view of a schematic diagram of an example of the transition of the data on the memory according to the first embodiment;

FIG. 9 is an explanatory view of a schematic diagram of an example of the transition of the data on the memory according to a comparison example;

FIG. 10 is a flowchart of the cryptographic key updating process by the communication device according to the first embodiment;

FIG. 11 is an explanatory view of a schematic diagram of an example of the transition of the data relating to the cryptographic key updating process;

FIG. 12 is a flowchart of a variation example of the cryptographic key updating process;

FIG. 13 is an explanatory view of a schematic diagram of an example of the transition of the data relating to a modified cryptographic key updating process;

FIG. 14 is a block diagram of the configuration of the communication device according to a second embodiment;

FIG. 15 is an example of the data stored in the communication device according to the second embodiment;

FIG. 16 is a flowchart of the receiving process performed when the communication device according to the second embodiment receives data;

FIG. 17 is a flowchart of the externally-originated access key updating process by the communication device according to the second embodiment;

FIG. 18 is a flowchart of the encrypted PDU receiving process by the communication device according to the second embodiment;

FIG. 19 is a flowchart of the internally-originated access key transporting process by the communication device according to the second embodiment; and

FIG. 20 is a timing chart of updating a shared key and an internally-originated access key according to the second embodiment.

### DESCRIPTION OF EMBODIMENTS

A type of reception device may be provided with a storage area for holding received ciphertext data in addition to a storage area for holding data obtained as a result of decryption by the latest cryptographic key in preparation for further decryption using an old cryptographic key.

However, depending on the application field of an encrypted communication system, the storage capacity of a reception device may be considerably restricted. From the viewpoint of the Applicants obtained as a result of their studies, a reception device having a small storage capacity may incur the degradation of performance or an error due to a shortage of memory by holding both of the data obtained as a result of decryption and received ciphertext data.

One of the objectives of the following embodiments is to provide a technique of allowing a communication device having a small storage capacity to easily perform the decryption using an old cryptographic key in an encrypted communication system in which a cryptographic key is updated.

A more concrete example is described later, but according to an aspect of the following embodiments, a communication device includes a data storage unit, a decryption unit, an encryption unit, and a judgment unit.

The data storage unit stores a piece of encrypted data or a piece of decrypted data. The decryption unit decrypts each provided piece of encrypted data. The encryption unit encrypts each provided piece of decrypted data.

The judgment unit issues an instruction to the encryption unit to read from the data storage unit first decrypted data obtained by the decryption unit decrypting first encrypted data with a cryptographic key, and to write back to the data storage unit second encrypted data obtained by the encryption unit encrypting the first decrypted data with the cryptographic key.

With the communication device described above, the cryptographic key used in decrypting the first encrypted data to the first decrypted data is the same as the cryptographic key used in encrypting the first decrypted data to the second encrypted data. Therefore, the content of the second encrypted data is the same as that of the first encrypted data.

Accordingly, the communication device above has an effect of saving the storage area by writing data back to the data storage unit. That is, since the second encrypted data having the same content as the first encrypted data is written back to the data storage unit, it is not necessary that the data storage unit continues holding the first encrypted data in the communication device above. That is, the communication device above has an effect of reducing the consumption of the storage area.

In addition, the cryptographic key in the communication device may be a cryptographic key to be updated, and the first encrypted data may be received by the communication device from another device. In this case, the communication device is allowed to perform decryption using an old cryptographic key without the necessity of holding the received data itself in addition to holding the decrypted data obtained by decrypting received data.

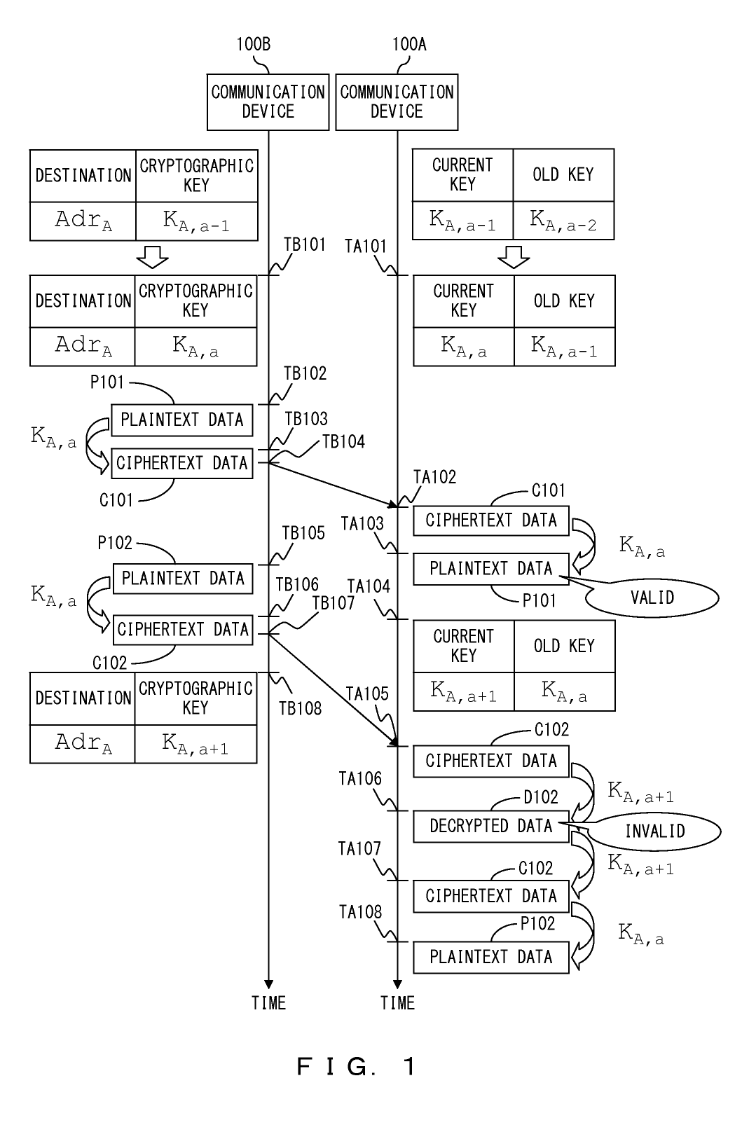

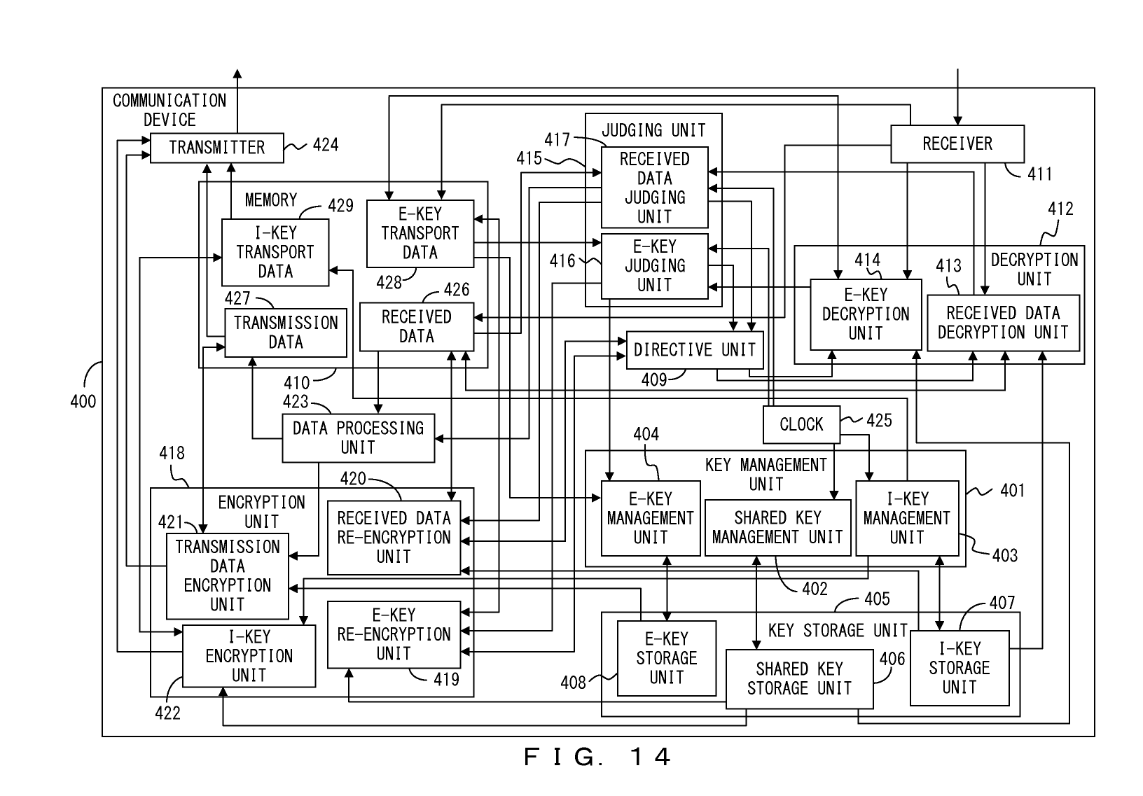

The embodiments are described below in more detail with reference to the attached drawings. To be concrete, the first embodiment is first described below with reference to FIGS. 1 through 13, and then the second embodiment is described with reference to FIGS. 14 through 20. Finally, other embodiments are described later.

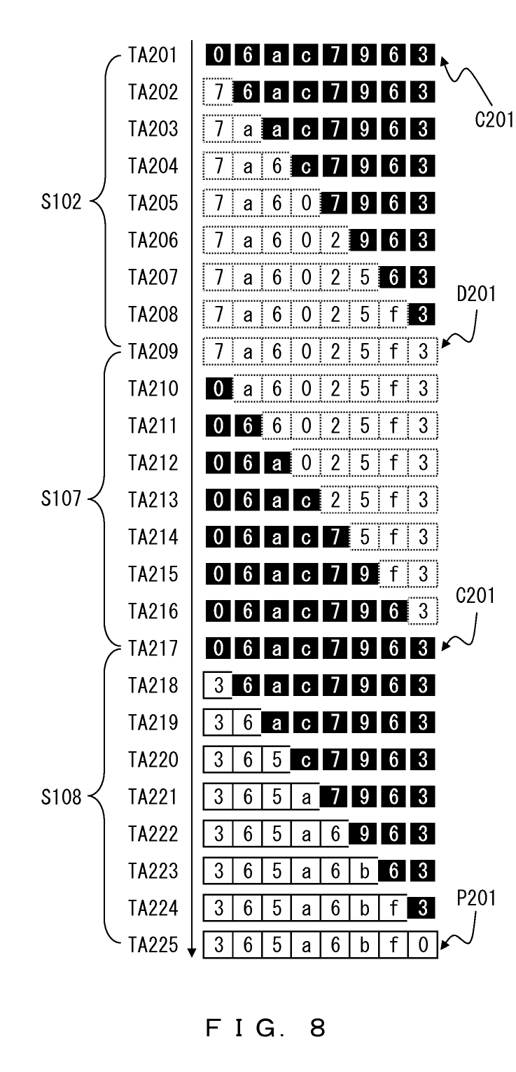

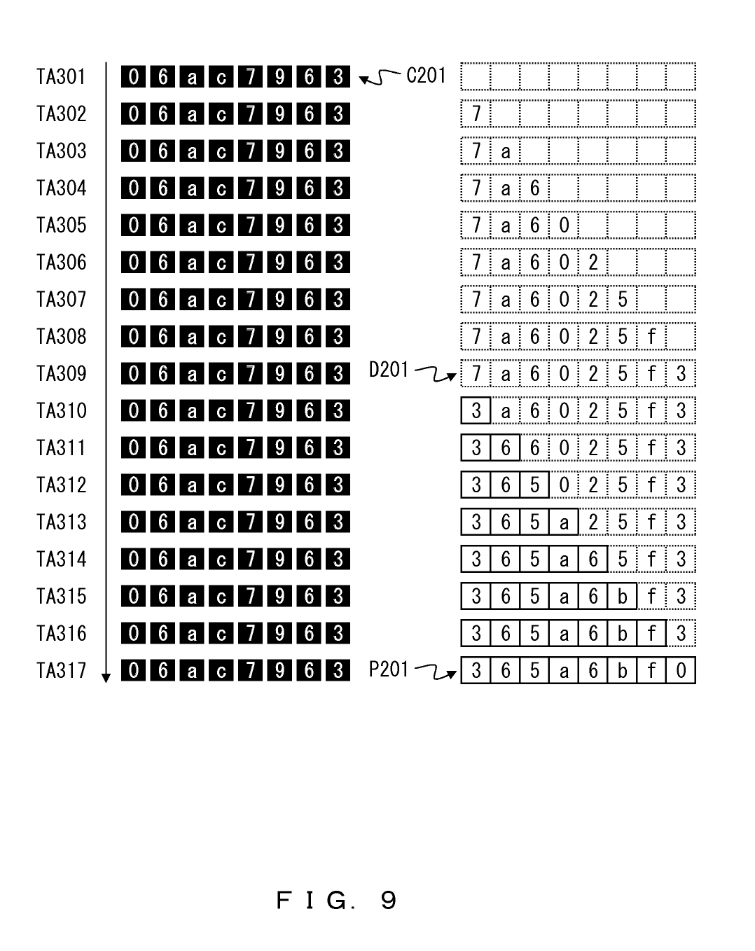

In the following description in the present specification, it is assumed that an encrypted communication is performed using symmetric cryptography unless otherwise specified. More detailed descriptions are given later with reference to FIGS. 8 and 9; either of stream cipher and block cipher is available in any embodiment.

FIG. 1 is a timing chart of an example of a communication according to the first embodiment. FIG. 1 is an example of a communication device 100B transmitting encrypted data to a communication device 100A.

Both of the communication devices 100A and 100B recognize the current cryptographic key used in performing decryption by the communication device 100A in any method of establishing a key. Since symmetric cryptography is used, a decryption key for the communication device 100A and an encryption key for the communication device 100B are the same cryptographic keys.

For example, the communication devices 100A and 100B may generate a cryptographic key according to the same algorithm. Otherwise, the communication device 100A may generate a cryptographic key, and transport the generated cryptographic key to the communication device 100B. For example, the communication device 100A may encrypt the generated cryptographic key using another cryptographic key for key transport and distribute the encrypted key to the communication device 100B. The cryptographic key for key transport used by the communication device 100A in encrypting the cryptographic key to be transported may be a cryptographic key for symmetric key cryptography, or a public key for the communication device 100B in public key cryptography.

As described above, the first embodiment is applicable to various types of encrypted communication system regardless of the practical method for the key establishment between the communication devices 100A and 100B.

In addition, a cryptographic key is updated at appropriate intervals between the communication devices 100A and 100B to improve the security of an encrypted communication. For convenience of explanation in the following decryptions, the cryptographic key to be updated is identified by the first generation, the second generation, . . . , and the cryptographic key of the a-th generation used in the decryption by the communication device 100A is expressed as “K_{A,a}”.

The transmitting communication device 100B associates the current cryptographic key to be used in decryption by the communication device 100A with the information for identifying the destination communication device 100A and stores the key. For convenience of explanation in the following decryption, the address Adr_{A} of the communication device 100A is used as the information for identifying the communication device 100A, but the identification information other than the address Adr_{A} is available.

The encrypted communication according to the first embodiment may be realized on the protocol of various layers. That is, the protocol data unit (PDU) according to the first embodiment is not limited to the PDU of a specific protocol of a specific layer. Therefore, the address Adr_{A} of the communication device 100A may be the address depending on the layer of a protocol.

For example, when the first embodiment is applied to the communication in the data link layer, the media access control (MAC) address may be used as the address Adr_{A} for identification of the communication device 100A. Otherwise, when the first embodiment is applied to the communication in the network layer, the Internet protocol (IP) address may be used as the address Adr_{A} for identification of the communication device 100A.

The encrypted communication according to the first embodiment may be a radio communication, a cable communication, or a combination of them. The hop count between the communication devices 100A and 100B may be 1 or more.

As illustrated in FIG. 1, for example, the communication device 100B recognizes the latest cryptographic key K_{A,a} of the communication device 100A at time TB101. Then, the communication device 100B replaces the cryptographic key K_{A,a-1} of the previous generation stored as associated with the address Adr_{A} of the communication device 100A with the new cryptographic key K_{A,a}.

On the other hand, the communication device 100A also generates the latest cryptographic key K_{A,a} at time TA101, and updates the cryptographic key (hereafter referred to as a “current key”) for use by the communication device 100A when it currently uses the key for decryption from the cryptographic key K_{A,a-1} of the previous generation to the new cryptographic key K_{A,a}. In addition, the communication device 100A according to the first embodiment also stores the cryptographic key of one generation prior to the generation of the current key (hereafter referred to as an “old key”). Therefore, at the time TA101, the communication device 100A also performs the process of updating the old key from K_{A,a-2} to K_{A,a-1}.

The times TB101 and TA101 refer to almost the same time, but the time TB101 may be earlier than the time TA101 and vice versa. Anyway, at the time point whichever later between the time TB101 and the time TA101, the cryptographic key K_{A,a} is established between the communication devices 100A and 100B.

The communication device 100B generates plaintext data P101 for transmission to the communication device 100A at time TB102. Then, the communication device 100B encrypts the plaintext data P101 using the cryptographic key K_{A,a} stored as associated with the address Adr_{A} of the destination communication device 100A, and obtains ciphertext data C101.

The protocol according to the first embodiment is arbitrary as described above, but generally the PDU includes a header and a payload. The plaintext data P101 and the ciphertext data C101 refer to the data corresponding to a payload. The type of the plaintext data P101 is arbitrary. The plaintext data P101 may be, for example, text data, image data, and binary data in the format of specific application software.

When the communication device 100B acquire the ciphertext data C101 as described above, the communication device 100B transmits the ciphertext data C101 to the communication device 100A at time TB104. To be precise, the communication device 100B transmits the PDU including the ciphertext data C101 as a payload, but the header is regardless of encryption. Therefore, the description of a header is appropriately omitted for simple explanation.

The ciphertext data C101 transmitted from the communication device 100B as described above is received by the communication device 100A at time TA102. At time TA102, the communication device 100A stores the cryptographic key K_{A,a} generated at the time TA101 as a current key. Therefore, the communication device 100A decrypts the ciphertext data C101 using the cryptographic key K_{A,a} at time TA103 after the time TA102.

As described above, the ciphertext data C101 is obtained by the encryption using the cryptographic key K_{A,a}. Therefore, by the decryption using the cryptographic key K_{A,a} at the time TA103, the same plaintext data P101 as generated by the communication device 100B at the time TB102 is obtained.

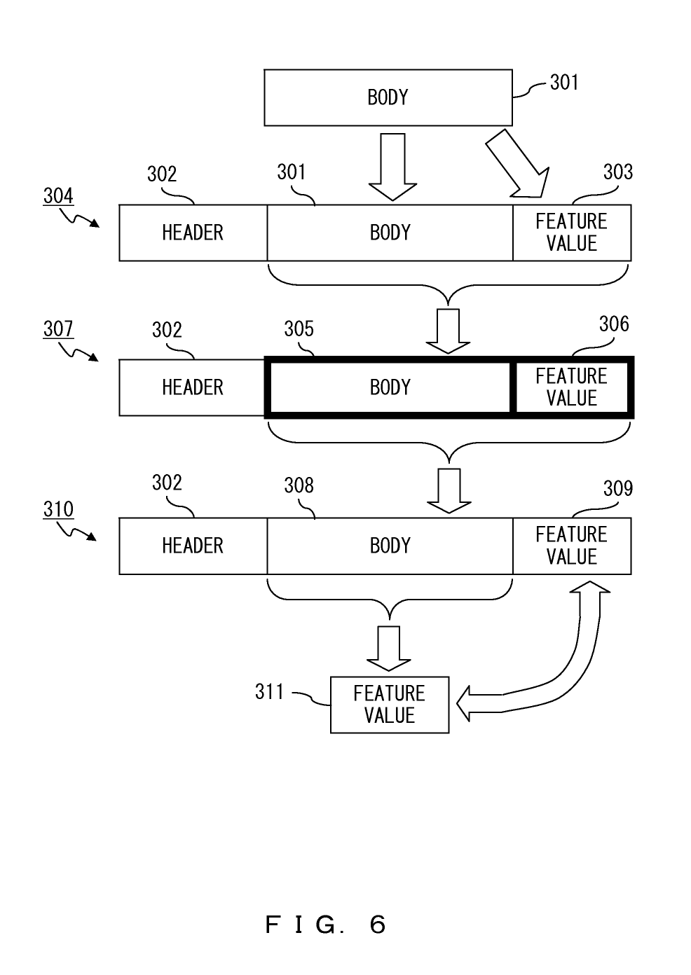

Furthermore, although described later in detail with reference to FIG. 6, the plaintext data P101 includes two portions, and the second portion indicates the feature of the first portion. In the description below, the value indicating the feature of the first portion is referred to as a “feature value”. In the second portion, the feature value itself, or the value obtained by performing a specified operation on the feature value is set.

Detailed descriptions are given later with reference to FIG. 6, but the feature value may be a hash value etc. Therefore, the communication device 100A checks the integrity of the plaintext data P101 using the feature value to confirm that the plaintext data P101 obtained by the decryption is correct plaintext data.

In the example in FIG. 1, the communication device 100B further generates another plaintext data P102 for a transmission to the communication device 100A at time TB105. Then, the communication device 100B encrypts the plaintext data P102 using the cryptographic key K_{A,a} at time TB106 as with the time TB103 to obtain ciphertext data C102. The communication device 100B then transmits the ciphertext data C102 at time TB107 as with the time TB104.

On the other hand, the communication device 100A updates the old key from cryptographic key K_{A,a-1} to cryptographic key K_{A,a} at time TA104 a little before receiving the ciphertext data C102 from the communication device 100B, and may update the current key to cryptographic key K_{A,a+1}. That is, the communication device 100A may receive the ciphertext data C102 at time TA105 after updating the cryptographic key at the time TA104.

Obviously, the communication device 100B updates the cryptographic key corresponding to the address Adr_{A} of the communication device 100A from the cryptographic key K_{A,a} to the cryptographic key K_{A,a+1} at time TB108 close to the time TA104 when the communication device 100A updates the cryptographic key. Therefore, at the time TB108 which comes later than the time TA104, anew cryptographic key K_{A,a+1} is established between the communication device 100A and the communication device 100B.

However, as described above, the communication device 100B may encrypt the plaintext data P102 at the time TB106 immediately before the update at the time TB108. In addition, immediately before the communication device 100A receives the ciphertext data C102 at the time TA105, the current key and the old key may be updated at the time TA104.

For example, as a method for establishing a key, when a method of transporting a new cryptographic key K_{A,a+1} generated by the communication device 100A to the communication device 100B is adopted, the ciphertext data C102 may be transmitted immediately before transporting the key. Otherwise, as a method of establishing a key, when a method of generating a cryptographic key according to the same algorithm by the communication devices 100A and 100B with reference to the respective time is adopted, the built-in clock of the communication device 100B may be behind the built-in clock of the communication device 100A. Furthermore, although the built-in clocks of the communication devices 100A and 100B correctly synchronize with each other, the current key may be updated during the time taken from the transmission to the reception of the ciphertext data C102.

For the various reasons above, as illustrated in FIG. 1, a cryptographic key K_{A,a+1} newer than the cryptographic key K_{A,a} used in generating the ciphertext data C102 may be stored as a current key already at the time TA105 when the communication device 100A receives the ciphertext data C102. In this case, the communication device 100A which has received the ciphertext data C102 decrypts the ciphertext data C102 using the current key K_{A,a+1} at time TA106.

Then, although decrypted data D102 is obtained, the decrypted data D102 is different from the plaintext data P102. By checking a feature value, the communication device 100A may judge that the decrypted data D102 is not correct plaintext data.

If the communication device 100A judges that the decrypted data D102 is not correct plaintext data, then it recognizes that the ciphertext data C102 may have been encrypted using the old key K_{A,a}. Then, the communication device 100A attempts to decrypt the ciphertext data C102 using the old key K_{A,a}. Therefore, the communication device 100A attempts decryption of the ciphertext data C102 using the cryptographic key K_{A,a}.

For saving memory, the communication device 100A according to the first embodiment does not generate the decrypted data D102 in a storage area different from the storage area of the ciphertext data C102, but it overwrites the decrypted data D102 in the storage area in which the ciphertext data C102 is stored. Therefore, in the phase of attempting the decryption of the ciphertext data C102 using the old key K_{A,a}, the communication device 100A does not hold the ciphertext data C102.

Then, the communication device 100A restores the ciphertext data C102 by re-encrypting the decrypted data D102 using the current key K_{A,a+1} at time TA107. For saving memory also in re-encrypting the data at the time TA107, the communication device 100A overwrites the ciphertext data C102 in the storage area in which the decrypted data D102 is stored.

Then, after restoring the ciphertext data C102 by the re-encryption, the communication device 100A decrypts the ciphertext data C102 using the old key K_{A,a} at time TA108. Since the ciphertext data C102 is decrypted this time using the same cryptographic key K_{A,a} used when the encryption is performed, the same plaintext data P102 generated by the communication device 100B at the time TB105 is obtained as a result of the decryption.

During the decryption at the time TA108, the communication device 100A overwrites the plaintext data P102 for saving memory on the storage area on which the restored ciphertext data C102 is stored. Then, by checking the feature value, the communication device 100A may confirm that the plaintext data P102 is correct plaintext data.

By the communication device 100A performing the above-mentioned re-decryption and the decryption with an old key, the communication device 100A is enabled to obtain correct plaintext data by the decryption with the old key even when correct plaintext data is not obtained by the decryption with the current key due to a timing shift. Therefore, the retransmission of data is not necessary. That is, it is not necessary for the communication device 100A to request the communication device 100B to retransmit data, or for the communication device 100B to re-encrypt the plaintext data P102 using a new cryptographic key K_{A,a+1} in response to the request, and transmit the obtained ciphertext data to the communication device 100A. In addition, it is not necessary for the communication device 100B to hold the plaintext data P102 for a while in preparation for a retransmission.

Therefore, the first embodiment has the following effects (1) through (3).

(1) Lower traffic between the communication devices 100A and 100B

(2) No excess use of storage area by the communication device 100B in preparation for a retransmission

(3) Since the time taken for re-encryption and re-decryption in the communication device 100A is shorter than the time taken for requesting a retransmission and retransmitting data, the communication device 100A may quickly obtain correct plaintext data P102.

Furthermore, the communication device 100A sequentially overwrites the received ciphertext data C102, the decrypted data D102, the ciphertext data C102 restored by the re-encryption, and the plaintext data P102 on the storage area as described above. Therefore, although the capacity of the memory loaded into the communication device 100A for any reason is restricted, the effects (1) through (3) above are acquired according to the first embodiment.

Although only the transmission of data from the communication device 100B to the communication device 100A is described with reference to FIG. 1, the communication device 100A may transmit data to the communication device 100B. In the description below, it is assumed that each communication device has both the functions of receiving and transmitting data.

For the bidirectional communication between the communication devices 100A and 100B, the communication device 100A further stores the latest cryptographic key K_{B,b} of the communication device 100B as associated with an address Adr_{B} of the communication device 100B for identification of the communication device 100B. Furthermore, the communication device 100B stores the latest cryptographic key K_{B,b} for use by the communication device 100B in the decryption as a current key, and stores the cryptographic key K_{B,b-1} of one generation before the current key as an old key.

Then, the bidirectional communication is enabled, and the communication device 100B is capable of performing re-encryption and re-decryption using an old key as necessary on the data transmitted from the communication device 100A to the communication device 100B. Therefore, although both the communication devices 100A and 100B are loaded with small capacity memory, the effects (1) through (3) are obtained.

As a concrete example of the communication device on which the memory capacity is restricted, for example, a communication device in a sensor network may be available. A sensor network is to collect various types of information from a number of sensors arranged in an appropriate place, and each node in the sensor network is a communication device having a built-in sensor. The sensor may be of any type, for example, an image sensor, a temperature sensor, a pressure sensor, an acceleration sensor, etc.

Depending on the uses, a sensor network including a large number of communication devices of several thousands through several hundreds of thousands of orders may be designed. Then, in the real society, when each communication device is expensive, it is impractical to design and operate a sensor network including a very large number of communication devices. Therefore, it is preferable that a communication device for a sensor network is inexpensive in production cost.

Then, to reduce the production cost, for example, it is effective to restrict the capacity of the built-in memory because the area of the integrated circuit (IC) used in a communication device is reduced by restricting the capacity of the built-in memory, and more ICs may be produced from one semiconductor wafer, thereby reducing the unit cost of an IC.

Therefore, the communication devices 100A and 100B according to the first embodiment are applicable as a communication device when the capacity of the built-in memory is restricted for any reason such as a communication device in a sensor network etc. Obviously, the effect of saving memory according to the first embodiment and the effects of (1) through (3) above are obtained although the communication device is loaded with memory having a sufficient capacity.

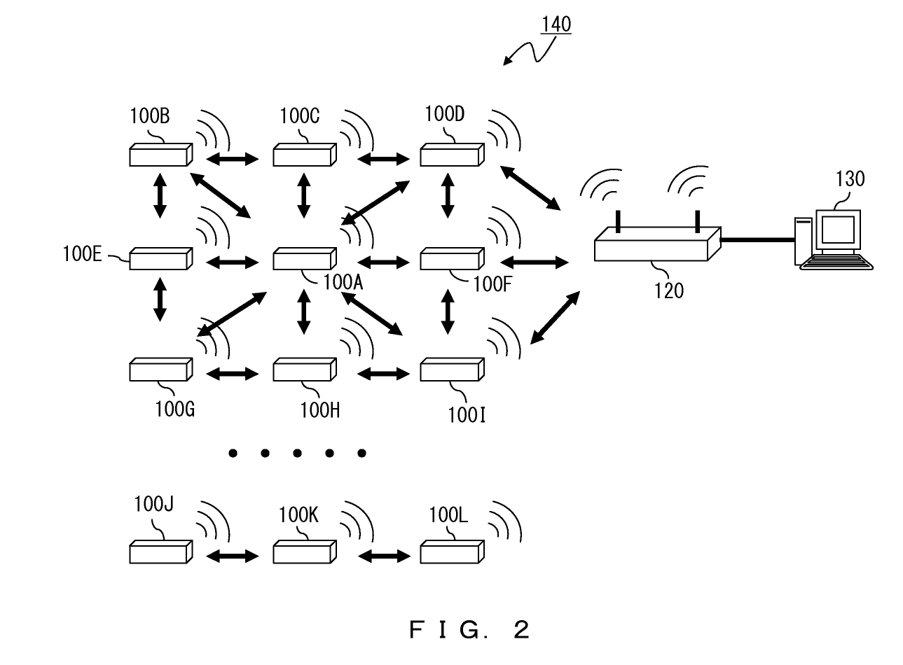

Thus, the communication devices 100A and 100B are applicable in various environments, and are concretely described below with reference to FIG. 2.

FIG. 2 is a system configuration of an example of an environment according to the first embodiment. The first embodiment is not limited to the application to a wireless communication network, but the communication devices 100A and 100B perform a wireless communication in the example illustrated in FIG. 2.

In FIG. 2, other communication devices 100C through 100L similar to the communication devices 100A and 100B are illustrated. FIG. 2 further illustrates a gateway device 120 and a server 130. An ad hoc network 140 in FIG. 2 is autonomously configured by the communication devices 100A through 100L and the gateway device 120.

In the example illustrated in FIG. 2, the communication device 100A may directly communicate with communication devices 100B through 1001 in the ad hoc network 140. That is, the communication devices 100B through 1001 have the hop count of 1 from the communication device 100A, and the hop count from the communication device 100A to the communication devices 100J through 100L is 2 or more.

The ad hoc network 140 may be used as a sensor network. That is, each of the communication devices 100A through 100L may be connected to a sensor or includes a sensor. In this case, each of the communication devices 100A through 100L transmits the PDU including the data detected by the sensor to the gateway device 120 through the ad hoc network 140.

In the example in FIG. 2, the communication devices 100D, 100F, and 1001 may communicate with the gateway device 120. Therefore, the PDU transmitted by the communication device 100A may reach the gateway device 120 by two hops through, for example, the communication device 100D. Also the PDU transmitted by other communication devices 100B through 100L reaches the gateway device 120 through an appropriate route in the ad hoc network 140.

Then, since the gateway device 120 is connected to the server 130, the PDU transmitted by each of the communication devices 100A through 100L is transferred from the gateway device 120 to the server 130. The gateway device 120 may be directly connected to the server 130, or indirectly connected through a network. In addition, the connection between the gateway device 120 and the server 130 is made by cable, by wireless, or by a combination of them.

Thus, the server 130 collects data detected by a sensor from each of the communication devices 100A through 100L in the ad hoc network 140 and analyzes the data. For example, when each sensor is a temperature sensor, the server 130 may check the temperature distribution or a temperature change, or perform a temperature predicting process.

Then, as illustrated in FIG. 1, the communication in the ad hoc network 140 is encrypted, and a cryptographic key is updated at appropriate intervals. Concretely, at least between two adjacent devices capable of directly communicating in the ad hoc network 140, a cryptographic key updated at appropriate intervals is shared in any method, thereby realizing the establishing a key.

For example, between the communication devices 100A through 100D capable of communicating by one hop, the mutual cryptographic key is shared. Similarly, also between the communication device 100D and the gateway device 120 capable of communicating by one hop, the mutual cryptographic key is shared. Therefore, the data detected by the sensor directly connected to or built inside the communication device 100A reaches from the communication device 100A through the communication device 100D in an encrypted state as described below.

The algorithm of deciding a data transfer route in the ad hoc network 140 is arbitrary, but is assumed as follows for convenience of explanation. That is, when the final destination in the ad hoc network 140 is the gateway device 120, it is assumed that the communication device 100A transmits the PDU to the communication device 100D in the adjacent communication devices 100B through 1001.

Therefore, under the assumption, the communication device 100A encrypts the data detected by the sensor using a cryptographic key of the communication device 100D which is stored as associated with the address of the communication device 100D. Then, the communication device 100A generates a PDU including the ciphertext data acquired by encryption as a payload, and transmits the generated PDU.

Then, the communication device 100D receives the PDU. As with the example in FIG. 1, the communication device 100D may acquire correct plaintext data from the PDU by the decryption using the current key. Otherwise, the communication device 100D may fail to acquire correct plaintext data in the first decrypting operation using the current key due to the shifted timing between establishing the key and transmitting and receiving the PDU. However, in this case, the communication device 100D may eventually obtain correct plaintext data by the re-encryption using the current key and the re-decryption using the old key.

Therefore, the communication device 100D encrypts using the cryptographic key of the gateway device 120 the plaintext data acquired by the decryption. Then, the communication device 100D generates a PDU including the ciphertext data obtained by the encryption as a payload, and transmits the generated PDU to the gateway device 120.

Then, the gateway device 120 receives the PDU. As with the example in FIG. 1, the gateway device 120 may obtain correct plaintext data from the PDU by the decryption using the current key. Otherwise, the gateway device 120 may fail to acquire correct plaintext data in the first decrypting operation using the current key due to the shifted timing between establishing the key and transmitting and receiving the PDU. However, in this case, the gateway device 120 may eventually obtain correct plaintext data by the re-encryption using the current key and the re-decryption using the old key.

Then, the gateway device 120 appropriately encrypts the plaintext data obtained by the decryption, generates a PDU including the ciphertext data obtained by the encryption as a payload, and transmits the generated PDU to the server 130. The encrypting algorithm used in the ad hoc network 140 and the encrypting algorithm used between the gateway device 120 and the server 130 may be the same as each other or different from each other.

The server 130 receives the PDU from the gateway device 120, and decrypts the payload of the received PDU, thereby acquiring the plaintext data as the data detected by the sensor connected to the communication device 100A (or built in the communication device 100A). The server 130 may similarly collect the data detected by the sensor from other communication devices 100B through 100L.

In the description above, the case in which mainly the ad hoc network 140 is used as a sensor network, but the ad hoc network 140 is not limited to a sensor network.

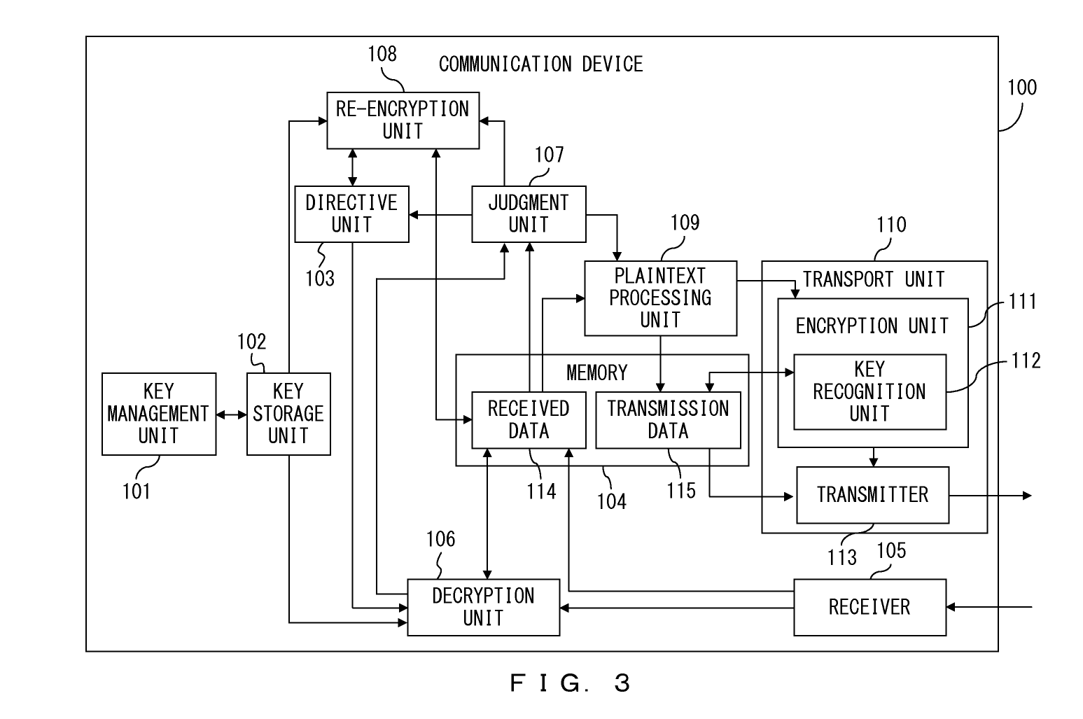

Next, the first embodiment is described further in detail with reference to FIGS. 3 through 13.

FIG. 3 is a block diagram of the configuration of the communication device according to the first embodiment. In the first embodiment, the communication devices 100A through 100L are communication devices 100 in FIG. 3, and the gateway device 120 has each unit illustrated in FIG. 3. In FIGS. 3 and 14, the intersecting arrow lines do not refer to a connection of the lines.

The communication device 100 in FIG. 3 includes a key management unit 101, a key storage unit 102, a directive unit 103, memory 104, a receiver 105, a decryption unit 106, a judgment unit 107, a re-encryption unit 108, a plaintext processing unit 109, and a transport unit 110. Then, the transport unit 110 includes an encryption unit 111, and the encryption unit 111 includes a key recognition unit 112. The details of each unit in the communication device 100 are described below.

The key management unit 101 repeatedly generates a cryptographic key for decryption by the communication device 100. Then, the key storage unit 102 is an example of a first storage unit for storing a plurality of cryptographic keys generated by the key management unit 101.

Practically, the key storage unit 102 according to the first embodiment stores two cryptographic keys as a current key and an old key as illustrated in FIG. 1. However, depending on the embodiments, the key storage unit 102 may store three or more cryptographic keys including a cryptographic key in the two or more generations before. In addition, the key management unit 101 not only operates as a key generation unit by repeatedly generating a cryptographic key as described above, but also manages relating to the cryptographic key by updating an old key when the cryptographic key is generated, etc.

Furthermore, the directive unit 103 selects one of a plurality of cryptographic keys stored in the key storage unit 102 as a selected cryptographic key. That is, the directive unit 103 selects a cryptographic key for use in the decryption or the re-encryption as a selected cryptographic key. The selected cryptographic key depends of the situation, and is described later in detail.

The memory 104 is an example of a second storage unit. FIG. 3 illustrates received data 114 and transmission data 115 stored on the memory 104. In FIG. 3, the data of the entire PDU including a header and a payload is illustrated as the received data 114 and the transmission data 115.

As understood from the explanation with reference to FIG. 1, the payload of the received data 114 may be the state of the received ciphertext and the state decrypted using a cryptographic key different from the key used in the encryption. Furthermore, the payload of the received data 114 may be a re-encrypted state and the state of a correct plaintext decrypted by the same cryptographic key used in the encryption. In addition, as described later, the payload of the transmission data 115 may refers to the state of plaintext, or the state of ciphertext.

That is, the memory 104 is an example of a data storage unit that stores a piece of encrypted data or a piece of decrypted data. The encrypted data is also referred to as ciphertext data. The decrypted data may be correctly decrypted plaintext data, and may be data decrypted using a cryptographic key different from the key used in the encryption.

The receiver 105 receives ciphertext data and stores the received ciphertext data in the memory 104. That is, the payload of the received data 114 in FIG. 3 is first in the state of the ciphertext when the receiver 105 stores the received data 114 in the memory 104.

Furthermore, the decryption unit 106 reads the selected cryptographic key specified by the directive unit 103 from the key storage unit 102, and decrypts using a selected cryptographic key the ciphertext data stored as a payload of the received data 114 in the memory 104. When the data is decrypted, the decryption unit 106 overwrites the ciphertext data on the memory 104 by the decrypted data obtained by the decryption. As a result, the payload of the received data 114 enters the state of the decryption using a selected cryptographic key. As described above with reference to FIG. 1, the memory 104 may be efficiently used by the overwrite.

The judgment unit 107 calculates a feature value indicating the feature of the first portion included in the decrypted data stored on the memory 104 as a payload of the received data 114. If the calculated feature value is consistent with the second portion included in the decrypted data, then the judgment unit 107 judges that the decrypted data is correct plaintext data. On the other hand, if the calculated feature value is not consistent with the second portion included in the decrypted data, then the judgment unit 107 judges that the decrypted data is invalid.

Then, when the judgment unit 107 judges that the decrypted data is invalid, the re-encryption unit 108 reads the selected cryptographic key specified by the directive unit 103 from the key storage unit 102, and encrypts the decrypted data on the memory 104 using the selected cryptographic key. Thus, the re-encryption unit 108 is a concrete example of an encryption unit for encrypting the decrypted data.

In the encryption, the re-encryption unit 108 overwrites the decrypted data on the memory 104 with the ciphertext data obtained again by the encryption. As a result, the payload of the received data 114 is returned to the original ciphertext. As described above with reference to FIG. 1, the memory 104 may be efficiently used by the overwrite.

As described above, the selected cryptographic key depends on the situation.

For example, when the receiver 105 receives ciphertext data, the directive unit 103 selects the current key as the latest cryptographic key generated by the key management unit 101 as a selected cryptographic key. Furthermore, the receiver 105 instructs the decryption unit 106 to decrypt the payload of the received data 114. Therefore, in this case, the decryption unit 106 decrypts using the current key the ciphertext data stored as the payload of the received data 114.

On the other hand, when the judgment unit 107 judges that the decrypted data is invalid, the directive unit 103 re-selects the cryptographic key different from the currently selected cryptographic key as a selected cryptographic key. In the first embodiment, the decrypted data is judged as invalid data when the selected cryptographic key is a current key. Therefore, the cryptographic key re-selected as a selected cryptographic key by the directive unit 103 is concretely an old key.

In addition, the timing of the directive unit 103 re-selecting a selected cryptographic key when the judgment unit 107 judges that the decrypted data is invalid is, to be more correct, the time point after the re-encryption unit 108 overwrites the decrypted data on the memory 104 with the ciphertext data according to the judgment by the judgment unit 107. When the selected cryptographic key is re-selected, the directive unit 103 instructs the decryption unit 106 to decrypt the payload of the received data 114. Therefore, in this case, the decryption unit 106 decrypts using an old key the ciphertext data stored as the payload of the received data 114.

An example of a concrete operation of each unit in FIG. 3 is described below in more detail with reference to an example of the communication device 100A in FIG. 1.

In the example in FIG. 1, the key management unit 101 of the communication device 100A generates the cryptographic keys K_{A,a-1}, K_{A,a}, K_{A,a+1}, etc. The key storage unit 102 stores the current key K_{A,a} and the old key K_{A,a-1} from the time TA101 to the point immediately before the time TA104. In addition, at and after the time TA104 until the key management unit 101 next updates the cryptographic key, the key storage unit 102 stores the current key K_{A,a+1} and the old key K_{A,a}.

When the receiver 105 of the communication device 100A receives the ciphertext data C101 at the time TA102, the directive unit 103 selects current key K_{A,a} as the latest cryptographic key. Therefore, the ciphertext data C101 stored as the payload of the received data 114 on the memory 104 is decrypted by the decryption unit 106 at the time TA103, and is overwritten by the plaintext data P101.

In this case, the judgment unit 107 judges from the feature value of the plaintext data P101 that the plaintext data P101 is correct. The plaintext processing unit 109 of the communication device 100A performs an appropriate process on the correct plaintext data P101 depending on the embodiment.

When the receiver 105 of the communication device 100A receives the ciphertext data C102 at the time TA105, the directive unit 103 selects the current key K_{A,a+1} as a selected cryptographic key. Therefore, the ciphertext data C102 stored as the payload of the received data 114 on the memory 104 is decrypted by the decryption unit 106 at the time TA106, and overwritten by the decrypted data D102.

In this case, the 107 judges from the feature value of the decrypted data D102 that the decrypted data D102 is not correct plaintext data (that is, the decrypted data D102 is invalid). Then, according to the judgment of the judgment unit 107, the re-encryption unit 108 encrypts the decrypted data D102 using the current key K_{A,a+1} selected as a selected cryptographic key at the time TA107. As a result, the decrypted data D102 stored as the payload of the received data 114 on the memory 104 is overwritten with the ciphertext data C102.

Furthermore, at the time TA108 after the re-encryption, the directive unit 103 re-selects the old key K_{A,a} different from the current key K_{A,a+1} currently selected as a selected cryptographic key, and instructs the decryption unit 106 to decrypt the ciphertext data C102. Then, the ciphertext data C102 stored as the payload of the received data 114 on the memory 104 is decrypted by the decryption unit 106 and overwritten with the plaintext data P102.

In this case, the judgment unit 107 judges from the feature value of the plaintext data P102 that the plaintext data P102 is correct. Then, the plaintext processing unit 109 performs an appropriate process on the plaintext data P102.

In addition to the processes performed when the cryptographic key used in the decryption by the communication device 100 in FIG. 3 is managed and when the data from another communication device 100 is received, the communication device 100 may also transmits data. The details of each unit relating to the transmission are concretely described below with reference to an example of the communication device 100B in FIG. 1.

The plaintext processing unit 109 not only processes the received data 114 whose payload is decrypted into correct plaintext data, but also may generate the transmission data 115 of plaintext on the memory 104 as the data to be transmitted to another communication device 100. For example, the plaintext processing unit 109 of the communication device 100B in FIG. 1 generates the plaintext data P101 and the header at the time TB102, stores the PDU including the plaintext data P101 and the header on the memory 104 as the transmission data 115, and instructs the encryption unit 111 to encrypt the PDU.

Then, the encryption unit 111 encrypts the plaintext data P101 stored as the payload of the transmission data 115 on the memory 104 at the time TB103. Concretely, since the key recognition unit 112 in the encryption unit 111 may recognize the cryptographic key K_{A,a} for use in the encryption, the encryption unit 111 encrypts the plaintext data P101 using the cryptographic key K_{A,a} recognized by the key recognition unit 112.

For example, by the plaintext processing unit 109 explicitly notifying the encryption unit 111 of the address Adr_{A} of the communication device 100A as the destination of the plaintext data P101, the encryption unit 111 may also recognize the address Adr_{A} of the destination. Otherwise, the encryption unit 111 may read the address Adr_{A} of the destination communication device 100A from the header on the memory 104.

Then, the key recognition unit 112 in the encryption unit 111 may recognize the cryptographic key for use in the encryption of the payload of the transmission data 115 to be transmitted to the address Adr_{A} from the address Adr_{A} recognized by the encryption unit 111 as the destination address. In the example in FIG. 1A, the key recognition unit 112 recognizes at the time TB103 that the cryptographic key used in the encryption of the payload of the transmission data 115 to be transmitted to the address Adr_{A} is the cryptographic key K_{A,a}. Therefore, the encryption unit 111 encrypts the plaintext data P101 stored as the payload of the transmission data 115 using the cryptographic key K_{A,a}.

In this case, as with the decryption by the decryption unit 106 and the re-encryption by the re-encryption unit 108, the encryption unit 111 also overwrites the same storage area on the memory 104. That is, the encryption unit 111 encrypts the plaintext data P101 stored on the memory 104 as the payload of the transmission data 115, and overwrites the plaintext data P101 with the ciphertext data C101 obtained by the encryption. By the overwrite above, the memory 104 may be efficiently used during the transmission.

When the encryption unit 111 completes the encrypting process, the unit instructs a transmitter 113 to transmit the transmission data 115. For example, at the time TB104, the transmitter 113 reads the transmission data 115 (that is, the data of the PDU including the ciphertext data C101) from the memory 104 at the instruction from the encryption unit 111. Then, the transmitter 113 transmits the PDU to the communication device 100A.

By the encryption unit 111 and the transmitter 113 in the transport unit 110 operating as described above, the transmission data 115 stored on the memory 104 is transported to another destination communication device 100 in the state in which the payload is encrypted.

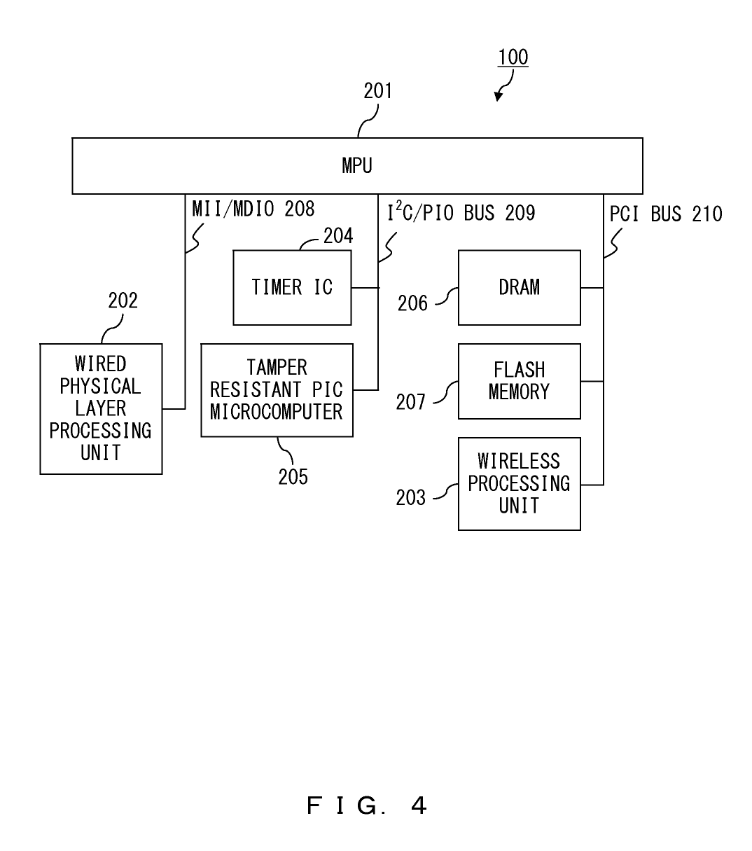

Next, a concrete example of the hardware realizing each unit in FIG. 3 is described below with reference to FIG. 4. FIG. 4 is an example of a configuration of the hardware of the communication device according to the first embodiment.

As illustrated in FIG. 4, the communication device 100 includes a micro-processing unit (MPU) 201. In addition, the communication device 100 includes at least one of a wired physical layer processing unit 202 and a wireless processing unit 203. The communication device 100 may further includes a timer IC 204 and a tamper resistant peripheral interface controller micro-computer (PIC microcomputer) 205. Furthermore, the communication device 100 includes dynamic random access memory (DRAM) DRAM 206 and flash memory 207.

The connection interface between the MPU 201 and the wired processing unit 202 may be, for example, a media independent interface (MII) or a management data input/output (MDIO) (hereafter referred to as a MII/MDIO 208). The MII and the MDIO are interfaces between the physical layer and the MAC sublayer.

The timer IC 204 and the tamper resistant PIC microcomputer 205 are connected to the MPU 201 through an inter-integrated circuit (I²C) bus or a parallel input/output (PIO) bus (hereafter referred to as an I²C/PIO bus 209). Then, the wireless processing unit 203, the DRAM 206, and the flash memory 207 are connected to the MPU 201 through a peripheral component interconnect (PCI) bus 210,

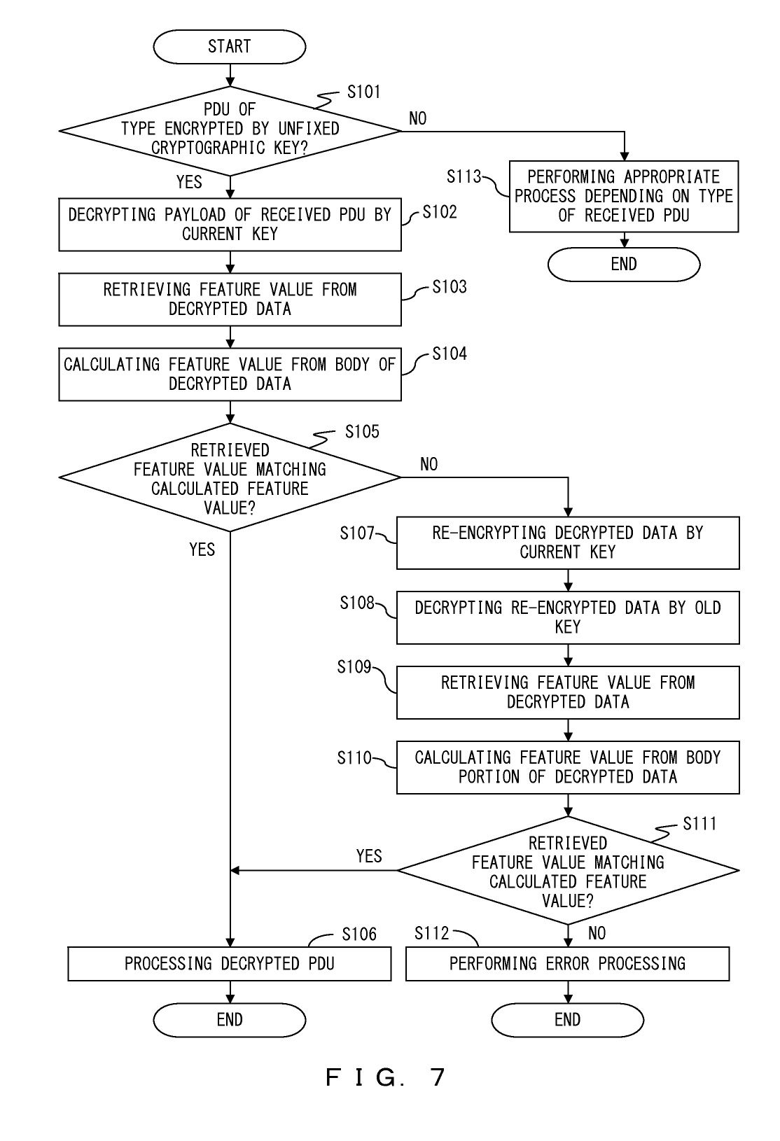

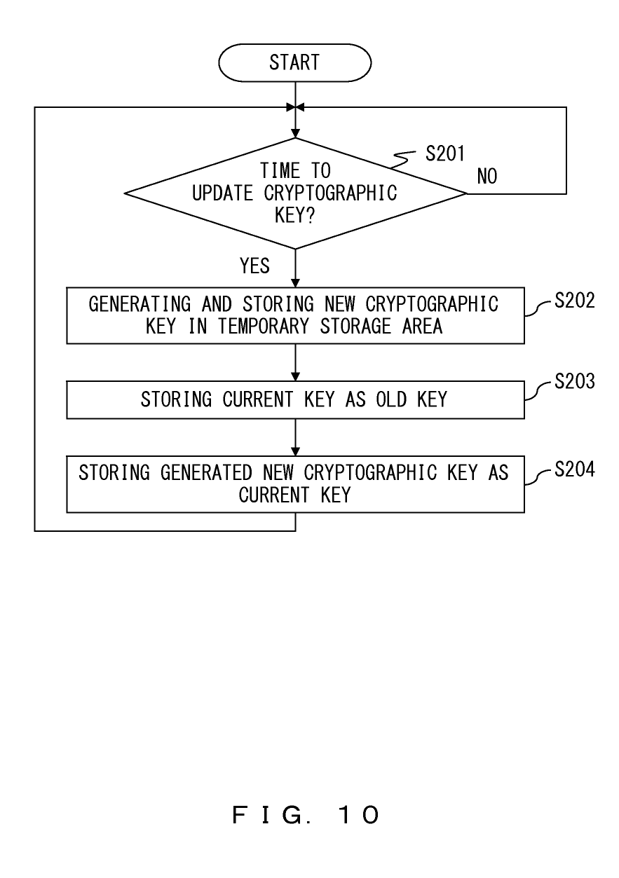

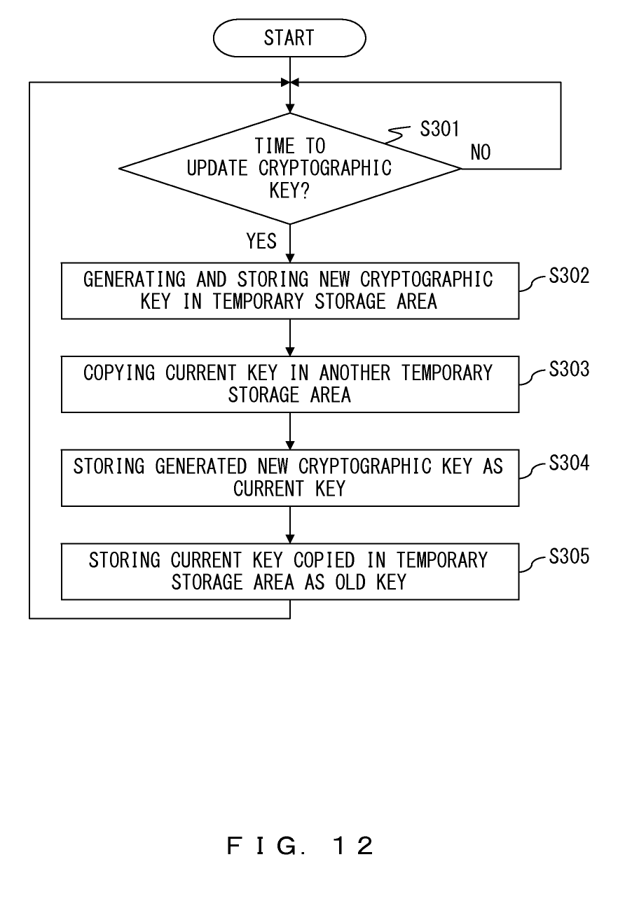

In the communication device 100, the MPU 201 performs various processes by loading various programs such as firmware etc. stored on the flash memory 207 as a type of non-volatile storage device into the DRAM 206 and executing the programs. An example of the program executed by the MPU 201 may be a driver of the tamper resistant PIC microcomputer 205, the program for the processes in FIG. 7 described later, the program for the process in FIG. 10 or 12 described later, etc.

The wired processing unit 202 is hardware including a physical port for connection of a cable and a circuit for processing a physical layer in a cable connection. The wireless processing unit 203 is hardware performing the processes of a physical layer and a MAC sublayer in the wireless connection, and includes an antenna, an analog/digital converter, a digital/analog converter, a modulator, a demodulator, etc.

The timer IC 204 performs a count-up operation until a set time elapses, and outputs an interrupt signal when the set time passes. The tamper resistant PIC microcomputer 205 is a micro-computer into which a specified algorithm is incorporated. Analyzing the specified algorithm from the outside results in failure because the tamper resistant PIC microcomputer 205 has the tamper resistance.

The DRAM 206 stores various types of data, and the flash memory 207 stores a firmware program etc. as described above. The flash memory 207 may further store information inherent to the communication device 100 itself such as the identification (ID) of the communication device 100 itself, a MAC address, etc. Depending on the embodiment, the communication device 100 may include another non-volatile memory such as read only memory (ROM), a hard disk device, etc. instead of or together with the flash memory 207.

In addition, a program may be installed in advance in the flash memory 207 or another non-volatile memory. Otherwise, a program may be downloaded from a network such as the ad hoc network 140 etc. and stores in the flash memory 207 or another non-volatile memory.

Obviously, depending on the embodiments, the communication device 100 may further include a drive device of a computer-readable storage medium. In this case, the program may be copied from the storage medium to the flash memory 207 or other non-volatile memory. As a storage medium, a semiconductor memory card, an optical disc such as a Compact Disc (CD), a digital versatile disk (DVD), a magneto optical disk, a magnetic disk, etc. are available. By various types of hardware described above with reference to FIG. 4, each unit illustrated in FIG. 3 is realized.

For example, the key management unit 101 in FIG. 3 may be realized by: the tamper resistant PIC microcomputer 205 for which the communication device 100 generates a cryptographic key for use in the decryption, and into which the algorithm of updating the storage content of the key storage unit 102 is incorporated; and the timer IC 204 in which the interval of updating the cryptographic key is set. Otherwise, the key management unit 101 may be realized by: the MPU 201 for which the communication device 100 generates a cryptographic key for use in the decryption, and for executing the program for updating the storage content of the key storage unit 102; and the timer IC 204 in which the interval of updating the cryptographic key is set. Obviously, the MPU 201 may recognize the time by the internal clock not according to the signal from the timer IC 204, and recognize the timing of updating the cryptographic key.

The cryptographic key for the decryption by the communication device 100 may be the cryptographic key inherent to the communication device 100 different for each communication device 100 depending on the content of the data transmitted by the communication device 100 and the application field, and may be the cryptographic key shared among a plurality of communication devices 100. The first embodiment is applied to either case.

The key storage unit 102 may be realized by the RAM in the tamper resistant PIC microcomputer 205, or the DRAM 206. Otherwise, the communication device 100 may further include another tamper resistant memory not illustrated in the attached drawings, and the tamper resistant memory may realize the key storage unit 102.

The directive unit 103, the decryption unit 106, the judgment unit 107, the re-encryption unit 108, and the plaintext processing unit 109 are realized by the MPU 201 for executing a program. Obviously, the hardware circuit exclusively for realizing each unit instead of the MPU 201 may be used. For example, the decryption unit 106 may be realized by a dedicated decryption circuit, and the re-encryption unit 108 may be realized by a dedicated encryption circuit.

The memory 104 is realized by the DRAM 206. Then, the receiver 105 and the transmitter 113 are realized by at least one of the wired processing unit 202 and the wireless processing unit 203 and the MPU 201 for executing a program.

The encryption unit 111 includes, for example, the MPU 201 for executing a program for encrypting the payload of the transmission data 115 or a dedicated encryption circuit. Then the key recognition unit 112 in the encryption unit 111 may be realized by the following hardware.

For example, the key recognition unit 112 may include: the MPU 201 for executing a program for generating a cryptographic key for use in the decryption by the communication device 100 and managing the key; and the timer IC 204 in which the interval of updating the cryptographic key for use by the communication device 100 in the decryption is set. Obviously, the hardware for generating and managing the cryptographic key for use by another communication device 100 in the decryption may be the tamper resistant PIC microcomputer 205, not the MPU 201.

Otherwise, the key recognition unit 112 may include the wired processing unit 202 or the wireless processing unit 203 for receiving a notification of the cryptographic key from another communication device 100. In this case, the key recognition unit 112 includes the MPU 201 for executing a program for recognizing a cryptographic key for use by another communication device 100 in the decryption from the received notification, and updating the storage content relating to the cryptographic key for use by another communication device 100 in the decryption.

The cryptographic key for use by the communication device 100 in the decryption may be a cryptographic key inherent to the other communication device 100, or a cryptographic key shared among a plurality of communication devices 100. The first embodiment may be applicable to either case.

Furthermore, the key recognition unit 112 includes the DRAM 206 or RAM in the tamper resistant PIC microcomputer 205 as hardware for storing a cryptographic key for use by the communication device 100 in the decryption. Otherwise, the communication device 100 may further include another tamper resistant memory not illustrated in the attached drawings, and the tamper resistant memory may be used as hardware for storing a cryptographic key for use by the communication device 100 in the decryption.

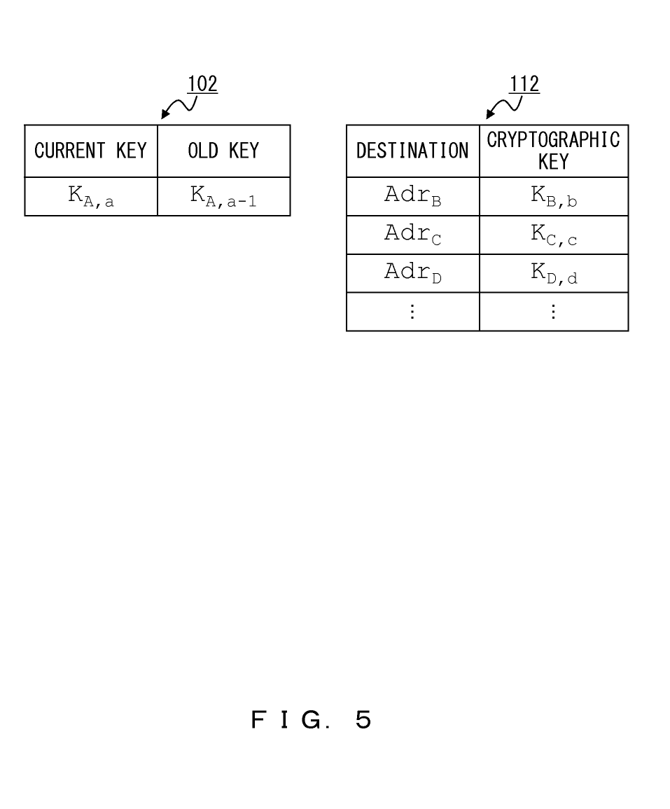

As described above by comparing FIG. 4 with FIG. 3, the communication device 100 may be realized by appropriate hardware depending on the embodiments. Then, the data used by the communication device 100 is described with reference to FIGS. 5 and 6, and then the process performed by the communication device 100 is described with reference to FIGS. 7 through 13.

FIG. 5 is an example of the data stored in the communication device according to the first embodiment. Concretely, FIG. 5 exemplifies the data stored in the key storage unit 102 and the key recognition unit 112 of the communication device 100A in FIG. 1.

The key storage unit 102 in FIG. 5 stores the cryptographic key K_{A,a} of the latest a-th generation generated by the key management unit 101 as a current key, and stores the cryptographic key K_{A,a-1} of the (a−1)-th generation generated before by the key management unit 101 as an old key. That is, FIG. 5 illustrates the state of the key storage unit 102 in the period after the time TA101 in FIG. 1 until the point immediately before the time TA104. As described above, the key management unit 101 repeatedly generates a cryptographic key, and updates the storage content of the key storage unit 102.

The key recognition unit 112 illustrated in FIG. 5 stores the cryptographic key of another communication device 100 having a key established with the communication device 100A as associated with the address. The example in FIG. 5 is concretely an example of the case in which the cryptographic key for use by the communication devices 100B, 100C, 100D, etc. in FIG. 2 in the decryption is realized by the key recognition unit 112 of the communication device 100A.

In this case, the key recognition unit 112 of the communication device 100A stores the latest cryptographic key K_{B,b} of the communication device 100B as associated with the address Adr_{B} of the communication device 100B. Similarly, the key recognition unit 112 stores the latest cryptographic key K_{C,c} of the communication device 100C as associated with the address Adr_{c} of the communication device 100C, and stores the latest cryptographic key K_{D,d} of the communication device 100D as associated with the address Adr_{D} of the communication device 100D. Obviously, the key recognition unit 112 of the communication device 100A may store a set of an address and a cryptographic key for another communication device 100.

The method of the key recognition unit 112 of the communication device 100A recognizing the latest cryptographic key of other communication devices 100B, 100C, 100D, etc. is arbitrary.

For example, the communication device 100B may notify the communication device 100A of the new cryptographic key K_{B,b+1}. In this case, the key recognition unit 112 of the communication device 100A recognizes the update of the cryptographic key of the communication device 100B according to the notification from the communication device 100B, and updates the cryptographic key corresponding to the address Adr_{B} from the cryptographic key K_{B,b} in the current b-th generation to the cryptographic key K_{B,b+1} in the new (b+1) generation.

Otherwise, the key recognition unit 112 of the communication device 100A may recognize the update timing of the cryptographic key K_{B,b} of the communication device 100B according to the lapse of time without communication with the communication device 100B. In this case, when the key recognition unit 112 of the communication device 100A recognizes the update timing of the cryptographic key K_{B,b} of the communication device 100B, it generates a new cryptographic key K_{B,b+1}, and updates the cryptographic key corresponding to the address Adr_{B} from the current cryptographic key K_{B,b} to a new cryptographic key K_{B,b+1}.

As described above, the key recognition unit 112 stores the cryptographic key of another communication device 100 as associated with the address of the other destination communication device 100, and updates the cryptographic key with appropriate timing.

When the cryptographic key for use by each communication device 100 in the decryption is different, the key recognition unit 112 stores the cryptographic key as associated with the address for identification of each communication device 100 as illustrated in FIG. 5. However, depending on the embodiments, the cryptographic key for use by the communication device 100 in the decryption may be shared. For example, there may be an embodiment in which a shared cryptographic key is used by all communication devices 100 in the ad hoc network 140. In this case, the key recognition unit 112 may recognize the current key stored in the key storage unit 102 as a cryptographic key for encryption of the transmission data 115, and it is not necessary to store a cryptographic key for each address as illustrated in FIG. 5.

FIG. 6 is an explanatory view of the format of the data transmitted and received according to the first embodiment. In the description below, for convenience of explanation, a concrete example of the communication device 100B transmitting data to the communication device 100A is described with reference to FIG. 6 as with the example in FIG. 1.

The plaintext processing unit 109 of the communication device 100B generates a body 301 of plaintext, generates a header 302 depending on the communication protocol, and calculates a feature value 303 from the body 301. Then, the plaintext processing unit 109 stores the plaintext PDU 304 including the header 302, the body 301, and the feature value 303 in the memory 104. The payload of plaintext PDU 304 corresponds to the portion of the body 301 and the feature value 303.

The feature value 303 may indicate the feature of the body 301. In FIG. 6, for simple explanation, the data of the feature value 303 is collectively added to the tailing of the body 301, but the data of the feature value 303 may be inserted as distributed to a plurality of points in the body 301.

For example, the plaintext processing unit 109 may calculate the feature value 303 using the hash function from all or a part of the body 301. That is, the feature value 303 may be a hash value. As a hash function for calculation of the feature value 303, for example, a mesh digest or an arbitrary hash function for use in generating a message integrity code (MIC) are available. The feature value 303 may be a value obtained by encrypting a hash value using a fixed cryptographic key.

Otherwise, the plaintext processing unit 109 may calculate an error detection code for all or a part of the body 301 as the feature value 303. For example, an error detection code (such as a parity, a checksum, a cyclic redundancy check (CRC), etc.) is available as the feature value 303. The error detection code includes an error correction code, and an error correction code such as a Hamming code, a Reed-Solomon code, etc. is available. In this case, the body 301 corresponds to an information bit, and the feature value 303 corresponds to a code bit calculated from the information bit.

When the plaintext processing unit 109 stores the plaintext PDU 304 including the feature value 303 in the memory 104, the unit instructs the encryption unit 111 to encrypt a payload for the plaintext PDU 304 corresponding to the transmission data 115 in FIG. 3. As a result, the body 301 of the plaintext is replaced with an encrypted body 305, and the feature value 303 of plaintext is replaced with the encrypted feature value 306. That is, the memory 104 stores ciphertext PDU 307 including the header 302, the encrypted body 305, and an encrypted feature value 306 as the transmission data 115.

Then, the transmitter 113 of the communication device 100B transmits the ciphertext PDU 307 to the communication device 100A. For example, the ciphertext data C101 in FIG. 1 is an example of the payload of the ciphertext PDU 307, and includes the encrypted body 305 and the encrypted feature value 306.

The ciphertext PDU 307 transmitted from the communication device 100B is received by the receiver 105 of the communication device 100A, and stored on the memory 104. Then, the decryption unit 106 decrypts the payload (that is, the encrypted body 305 and the encrypted feature value 306) of the ciphertext PDU 307 using the current key.

As a result, the memory 104 stores a decrypted PDU 310 including the header 302, a decrypted body 308, and a decrypted feature value 309. The judgment unit 107 reads the decrypted body 308 from the memory 104, and calculates a feature value 311 from the decoded body 308. The algorithm of the judgment unit 107 calculating the feature value 311 from the decrypted body 308 is the same as the algorithm of the plaintext processing unit 109 calculating the feature value 303 from the body 301.

Then, the judgment unit 107 compares the calculated feature value 311 with the decrypted feature value 309. If the calculated feature value 311 matches the decrypted feature value 309, the judgment unit 107 judges that the payload of the decrypted PDU 310 is valid plaintext data.

On the other hand, if the calculated feature value 311 does not match the decrypted feature value 309, the judgment unit 107 judges that the payload of the decrypted PDU 310 is invalid. That is, the judgment unit 107 estimates that the old key not the current key has been used in encrypting the ciphertext PDU 307.

Then, the judgment unit 107 instructs the re-encryption unit 108 to encrypt the payload of the decrypted PDU 310. The re-encryption unit 108 encrypts the payload of the decrypted PDU 310 using the current key, and restores the ciphertext PDU 307 on the memory 104. Upon completion of the encrypting process, the re-encryption unit 108 notifies the directive unit 103 of the completion of the encryption.

Therefore, when the notification from the re-encryption unit 108 is received, the directive unit 103 switches the selected cryptographic key from the current key to the old key, and instructs the decryption unit 106 to decrypt the payload of the ciphertext PDU 307. After the decryption by the decryption unit 106, the judgment is made by the judgment unit 107 as described above, and if valid plaintext data has been acquired, the plaintext processing unit 109 processes valid plaintext data.

With reference to FIGS. 7 through 13, the operation of the above-mentioned communication device 100 is described below further in detail.

FIG. 7 is a flowchart of the receiving process performed when the communication device according to the first embodiment receives data. Upon receipt of the PDU, the receiver 105 stores the data of the received PDU as the received data 114 in the memory 104. Therefore, the memory 104 stores the received data 114 when the receiving process in FIG. 7 is started.

Although the PDU addressed to another communication device 100 is physically received according to some communication protocols, the receiver 105 judges from the header of the received PDU before starting the receiving process in FIG. 7 whether or not the address refers to the communication device 100 itself. The receiver 105 discards the received data 114 when the address does not refer to the communication device 100 itself. If the address refers to the communication device 100 itself, the receiving process in FIG. 7 is started.

In step S101, the receiver 105 judges from the header whether or not the PDU is to be encrypted by an unfixed cryptographic key.

If the received PDU is the PDU to be encrypted by an unfixed cryptographic key, the receiver 105 instructs the decryption unit 106 to decrypt the payload of the received data 114, thereby passing control to step S102. If the received PDU is another type of PDU, control is passed to step S113.

The first embodiment is an example of including a field indicating the type of PDU. However, for example, when all types of PDUs are to be encrypted by an unfixed cryptographic key, steps S101 and S113 described later may be omitted.

In step S102, the decryption unit 106 decrypts the payload of the received data 114 at the instruction from the receiver 105. Practically, the decryption unit 106 obtains from the directive unit 103 the information as to which cryptographic key is a selected cryptographic key, and reads the selected cryptographic key from the key storage unit 102, and decrypts the payload of the received data 114 using the selected cryptographic key.

In the initial state in which the communication device 100 is powered up, the directive unit 103 selects the current key as a selected cryptographic key. The process in FIG. 7 is performed each time a PDU is received, but the directive unit 103 selects the current key as a default selected cryptographic key when the process in FIG. 7 is terminated as described later relating to steps S105 and S111. Therefore, in step S102, the selected cryptographic key is the current key.

Accordingly, in step S102, the decryption unit 106 obtains from the directive unit 103 the information that the selected cryptographic key is the current key, reads the current key from the key storage unit 102, and decrypts the payload of the received data 114 using the current key. When the decryption in step S102 is performed, the decryption unit 106 overwrites the ciphertext of the payload of the received data 114 with the decrypted data as described above. By the overwrite described above, the excess consumption of the storage area is suppressed.

Upon completion of the decryption, the decryption unit 106 notifies the judgment unit 107 of the completion of the decryption. Then, control is passed to step S103.

In step S103, the judgment unit 107 which has received the notification from the decryption unit 106 retrieves a feature value from the decrypted data. That is, the judgment unit 107 reads the decrypted feature value 309 in FIG. 6 from the memory 104.

Then, in the next step S104, the judgment unit 107 calculates the feature value from the body of the data decrypted by the decryption unit 106. That is, the judgment unit 107 reads the decrypted body 308 in FIG. 6 from the memory 104, and calculates the feature value 311 according to a specified algorithm from the decrypted body 308. Steps S103 and S104 may be executed in the reverse order, or in parallel.

Next, in step S105, the judgment unit 107 judges whether or not the retrieved feature value matches the calculated feature value.

When the two feature values match each other, the judgment unit 107 judges that the payload of the received data 114 decrypted in step S102 and stored on the memory 104 is valid plaintext data. In this case, the judgment unit 107 instructs the plaintext processing unit 109 to perform the process of the received data 114 on the memory 104.

When two feature values match each other, the judgment unit 107 may instructs the directive unit 103 to reset the selected cryptographic key in preparation for the reception of the next PDU. Then, the directive unit 103 may select again the current key which is a default selected cryptographic key as a selected cryptographic key. Obviously, since the selected cryptographic key in step S105 is a current key, the explicit reset of a selected cryptographic key may be omitted. When two feature values match each other, control is passed to step S106.

On the other hand, when two feature values do not each other, the judgment unit 107 judges that the payload of the received data 114 decrypted in step S102 and stored on the memory 104 is invalid. In this case, the judgment unit 107 instructs the re-encryption unit 108 to re-encrypt the payload of the received data 114 on the memory 104 and restore the received data 114 to the original state. That is, the judgment unit 107 instructs the re-encryption unit 108 to read the data decrypted by the decryption unit 106 based on the selected cryptographic key from the memory 104 and overwrite the encrypted data obtained by encrypting the decrypted data based on the selected cryptographic key on the memory 104. Then, control is passed to step S107.

In step S106, the plaintext processing unit 109 processes the PDU decrypted by the decryption unit 106. That is, the plaintext processing unit 109 reads the data whose payload is decrypted to valid plaintext and stored as the received data 114 on the memory 104, and performs an appropriate process. Then, the process in FIG. 7 terminates.

Although the type of the process in step S106 is arbitrary depending on the embodiment, for example, when the communication device 100 is used as a node in the ad hoc network 140 used as a sensor network, the plaintext processing unit 109 may perform the following process.

For example, assume that the communication device 100A in FIG. 2 has received a PDU from a communication device 100E. In addition, assume that, according to an appropriate algorithm depending on the embodiment, the communication device 100A recognizes as follows relating to the route. That is, assume that the communication device 100A recognizes that it is appropriate that a received PDU is transferred to the communication device 100D if the PDU whose final destination in the ad hoc network 140 is the gateway device 120 is received.

In this case, the plaintext processing unit 109 of the communication device 100A decides to use the payload of the received data 114 including the data obtained by the communication device 100E or another communication device 100 not in the attached drawings from the sensor as the payload of the transmission data 115. For example, the plaintext processing unit 109 may generate the transmission data 115 by overwriting data in the storage area of the received data 114 by overwriting the address Adr_{D} of the destination communication device 100D on the header of the received data 114. When the transmission data 115 is well prepared, the plaintext processing unit 109 instructs the encryption unit 111 to encrypt the transmission data 115.

Then, using the cryptographic key K_{D,d} recognized by the key recognition unit 112 as associated with the address Adr_{D} of the destination communication device 100D, the encryption unit 111 encrypts the transmission data 115, and the transmitter 113 transmits the transmission data 115. As a result, the PDU including the data obtained from a sensor by the communication device 100E or another communication device 100 not illustrated in the attached drawings is transferred from the communication device 100A to the communication device 100D.

Obviously, the process other than the above-mentioned transfer process may be performed in step S106 depending on the embodiments. For example, when the received data 114 and the transmission data 115 is the data of the PDU of the data link layer, the plaintext processing unit 109 may process data according to the protocol of the layer upper than the network layer. Otherwise, when the received data 114 and the transmission data 115 are the data of the PDU in the network layer, the plaintext processing unit 109 may process data according to the protocol of the layer upper than the transport.

In step S107, the re-encryption unit 108 re-encrypts using the current key the data decrypted by the decryption unit 106. Concretely, the re-encryption unit 108 acquires the information from the directive unit 103 that the selected cryptographic key is a current key. Then, the re-encryption unit 108 reads the current key from the key storage unit 102, and encrypts the payload of the received data 114 using the current key.

During the encryption in step S107, the re-encryption unit 108 overwrites the payload of the received data 114 with the encrypted data as described above. By the overwrite, the excess consumption of the storage area is suppressed.

When the encryption is completed, the re-encryption unit 108 notifies the directive unit 103 of the completion of the encryption. Then, the directive unit 103 instructs the decryption unit 106 to re-select as a selected cryptographic key the old key which is a cryptographic key different from the currently selected cryptographic key, and decrypt the payload of the received data 114.

Then, in step S108, the decryption unit 106 decrypts the data re-encrypted by the re-encryption unit 108 using the old key. Concretely, the decryption unit 106 first acquires the information from the directive unit 103 that the selected cryptographic key is an old key. Then, the decryption unit 106 reads the old key from the key storage unit 102, and decrypts the payload of the received data 114 using the old key.

The decryption unit 106 overwrites the ciphertext of the payload of the received data 114 with the decrypted data as in step S102. By the overwrite, the excess consumption of the storage area is suppressed.

When the decryption is completed, the decryption unit 106 notifies the judgment unit 107 of the completion of the decryption. Then, control is passed to step S109.

In step S109, the judgment unit 107 retrieves a feature value from the data obtained by the decryption of the decryption unit 106 as in step S103.

In the next step S110, the judgment unit 107 calculates a feature value from the body of the data decrypted by the decryption unit 106 as in step S104. The processes in steps S109 and S110 may be executed in the reverse order or in parallel.

In the next step S111, the judgment unit 107 judges whether or not the retrieved feature value matches the calculated feature value.

If the two feature values match each other, the judgment unit 107 judges that the payload of the received data 114 decrypted in step S108 and stored on the memory 104 is valid plaintext data. In this case, the judgment unit 107 instructs the plaintext processing unit 109 to process the received data 114 on the memory 104.

When the two feature values match each other, the judgment unit 107 instructs the directive unit 103 to reset the selected cryptographic key in preparation for the reception of the next PDU. Then, the directive unit 103 re-selects the current key as a selected cryptographic key. Therefore, the selected cryptographic key becomes a current key when the next PDU is received and the process in FIG. 7 is started again. As described above, when the instruction to the plaintext processing unit 109 and the selected cryptographic key are switched, control is passed to step S106.

On the other hand, when two feature values do not match each other, the judgment unit 107 judges that the payload of the received data 114 decrypted in step S108 and stored on the memory 104 is invalid. No matching between the two feature values in step S111 indicates that correct plaintext data is not obtained by decrypting the payload of the received PDU using the current key or the old key. Therefore, in this case, the judgment unit 107 judges that any error has occurred.

Furthermore, in the first embodiment, since the key storage unit 102 holds only the cryptographic keys of the two generations, that is, the current key and the old key, there is no cryptographic key of another generation to be processed. Therefore, although the two feature values do not match each other, the judgment unit 107 instructs the directive unit 103 to reset the selected cryptographic key in preparation for the reception of the next PDU. Then, the directive unit 103 re-selects the current key as a selected cryptographic key. Accordingly, the selected cryptographic key becomes a current key when the next PDU is received and the process in FIG. 7 is started again. As described above, when an occurrence of an error is recognized and a selected cryptographic key is switched, control is passed to step S112.

The judgment unit 107 may recognize that when the notification of the completion of the decryption is first received from the decryption unit 106 after an instruction to perform re-encryption is issued to the re-encryption unit 108, the result of the decryption by the old key is verified. On the other hand, the judgment unit 107 may recognize that the result of the decryption by the current key is verified if the not is not the first decryption completion notification after the issue of the instruction to perform re-encryption to the re-encryption unit 108.

Therefore, the judgment unit 107 may appropriately operate unless the information about the type of the selected cryptographic key is explicitly obtained from the directive unit 103. That is, the judgment unit 107 may recognize without explicit information from the directive unit 103 whether it is to instruct the re-encryption unit 108 to re-encrypt the payload of the received data 114, or to recognize an occurrence of an error. The judgment unit 107 may explicitly obtain from the directive unit 103 the information about the type of selected cryptographic key.

In step S112, the judgment unit 107 performs appropriate error processing. Otherwise, the judgment unit 107 may instruct the error processing unit not illustrated in the attached drawings to perform the error processing. The details of the error processing are arbitrary. For example, the error processing may be to release the storage area of the received data 114, or to request another source communication device 100 to retransmit a PDU. After performing the error processing, the process in FIG. 7 terminates.

If the receiver 105 judges in step S101 that the received PDU is not to be encrypted by an unfixed cryptographic key, then an appropriate process is performed depending on the type of the received PDU.

The subject of the process, the details of the process, and the type of PDU in step S113 are arbitrary depending on the embodiments. For example, if a controlling PDU to be encrypted by a fixed cryptographic key is received, the controlling PDU processing unit not illustrated in the attached drawings may perform the process in step S113. For example, the PDU for time synchronization may be encrypted by a fixed cryptographic key in the ad hoc network 140. In this case, the time synchronization process may be performed in step S113. Otherwise, when a PDU which is to be transmitted without encryption is received, the plaintext processing unit 109 may perform the process in step S113. Anyway, an appropriate process is performed depending on the type of PDU, thereby terminating the process in FIG. 7.

Then, with reference to FIGS. 8 and 9, memory saving is described below in detail.

FIG. 8 is an explanatory view of a schematic diagram of an example of the transition of the data on the memory according to the first embodiment. FIG. 9 is an explanatory view of a schematic diagram of an example of the transition of the data on the memory according to a comparison example.

In FIGS. 8 and 9, the black background indicates ciphertext, and the white background with a solid line frame indicates correct plaintext data. The white background with a broken line frame indicates invalid data obtained as a result of decryption using a cryptographic key different from the key used in the encryption.

The type of the encryption used by the communication device 100 is symmetric cryptography. When the type of the encryption used by the communication device 100 is described from another viewpoint, the communication device 100 may use stream cipher or block cipher.

That is, if the length of a data unit to be encrypted and decrypted is equal between plaintext and ciphertext, and the sequence of data units is unchanged between plaintext and ciphertext, then any type of cryptography is available according to each embodiment. In the case of the stream cipher, the data unit to be encrypted and decrypted is 1 bit or 1 byte. In the case of the block cipher, the data unit to be encrypted and decrypted is a block. In the description below, for convenience of explanation, the case in which the stream cipher is used is mainly described.

Furthermore, in the description below, it is assumed that the prefix of “0x” indicates a hexadecimal number. Then, the overwrite of the area on the memory 104 insteps S102, S107, and S108 is described with reference to FIG. 8 using as an example the case in which a PDU including the payload of 4 bytes is received. In FIGS. 8 and 9, the progress of the decryption and the encryption is illustrated as a schematic diagram of the states indicated each time the 4-bit process is performed.

For example, at time TA201 in FIG. 8, assume that the receiver 105 stores ciphertext data C201 of 0x06ac7963 on the memory 104 as the payload of the received data 114.

Then, as the decryption unit 106 performs the decryption in step S102 in FIG. 7, the bits encrypted in the ciphertext data C201 are decrypted by the current key in order from the leading bit as illustrated as the states at time TA202 through TA209 in FIG. 8. Then, the encrypted bits are overwritten with the decrypted bits. Therefore, when the decryption in step S102 is terminated at the time TA209, decrypted data D201 obtained by the decryption is stored in the storage area of the memory 104 in which the ciphertext data C201 is originally stored. In the example in FIG. 8, the decrypted data D201 is 0x7a6025f3.

Thus, according to the first embodiment, since the ciphertext data C201 stored in the storage area is overwritten with the decrypted data D201, the use efficiency of the memory is high. When the block cipher is used, as in the case of the stream cipher, the ciphertext data C201 may be overwritten with the decrypted data D201. That is, although the block cipher is used, it is sufficient to have a temporary storage area of the block size on the memory 104, and it is not necessary to assign a storage area to each of the ciphertext data C201 and the decrypted data D201.

In addition, since similar overwrite is performed not only in the decryption in step S102 but also in the re-encryption in step S107 and in the decryption in step S108, the use efficiency of memory is high according to the first embodiment.

Concretely, as the re-encryption unit 108 proceeds with the re-encryption in step S107, the bits of the decrypted data D201 are encrypted by the current key in order from the leading bit as illustrated as the state at time TA210 through TA217. Then, each bit in the decrypted data D201 is overwritten with the encrypted bits. Therefore, when the re-encryption in step S107 is completed at the time TA217, the ciphertext data C201 restored by the re-encryption is stored on the storage area of the memory 104 on which the decrypted data D201 has been stored.

Then, as the decryption unit 106 proceeds with the decryption in step S108, the bits encrypted in the ciphertext data C201 are decrypted in order from the leading bit by the current key. Then, the encrypted bits as illustrated as the state of the time TA218 through TA225 in FIG. 8. Then, the encrypted bits are overwritten with the decrypted bits. Therefore, when the decryption in step S108 is completed at the time TA225, plaintext data P201 obtained by the decryption is stored on the storage area of the memory 104 in which the ciphertext data C201 has been stored. In the example in FIG. 8, the plaintext data P201 is 0x365a6fb0 in the example in FIG. 8.

The effect of memory saving by the overwrite above is more apparent when the comparison example in FIG. 8 is compared with FIG. 8. In the comparison example in FIG. 9, when the ciphertext data C201 is stored in the memory 104 at the time TA301, the ciphertext data C201 is continuously held in the memory 104 in preparation for the decryption by the old key when correct plaintext data is not acquired by the decryption using the current key. That is, in the decryption performed at time TA302 through TA309, each bit of the decrypted data D201 obtained in the decryption using the current key is sequentially written in the storage area other than the storage area of the ciphertext data C201.

Then, the feature value calculated from the body portion (for example, first 3 bytes of 0x7a6025) in the decrypted data D201 is compared with the feature value included in the decrypted data D201 (for example, the final 1 byte of 0xf3). If it is judged from the comparison result that the decrypted data D201 is not valid plaintext data, the ciphertext data C201 stored in a storage area other than the decrypted data D201 is decrypted using an old key in the comparison example in FIG. 9.

The result of the decryption by the old key may be, for example, overwritten in the storage area in which unnecessary decrypted data D201 is stored, but when the comparison example in FIG. 9 is compared with the example of the first embodiment in FIG. 8, an excess storage area is consumed. That is, in the decryption by the old key performed at time TA310 through TA317, each bit of the plaintext data P201 is sequentially written to the storage area different from the storage area of the ciphertext data C201.

When the first example is compared with the comparison example in FIG. 9, it is understood that the time taken for the re-encryption and the consumed storage area have the relationship of trade-off. However, for example, the first embodiment capable of performing decryption by an old key while saving a storage area is preferable even taking some time in re-encryption when the capacity of the memory 104 is strictly limited for any reason such as the application to a sensor network etc.

Regardless of whether the encryption and the decryption are performed by the MPU 201 for executing a program or by a hardware circuit, the processing speed of encrypting and decrypting in the symmetric cryptography is generally high. Therefore, the time taken for re-encryption may be an ignorable level in many cases. That is, although the processing time and the storage capacity have the relationship of trade-off, the capacity reduction of the storage area has a larger impact that a shorter time taken for the re-encryption in a certain environment such as a sensor network etc. Obviously, although the communication device 100 according to the first embodiment is not limited to a communication device in a sensor network, the communication device 100 is preferable as, for example, a communication device in a sensor network.

The process performed when the communication device 100 receives a PDU is described above with reference to FIGS. 7 through 9, but the communication device 100 also performs an independent process from the reception of a PDU. That is, the communication device 100 also updates a cryptographic key. Two processing methods relating to the update of the cryptographic key are described below with reference to FIGS. 10 through 13.

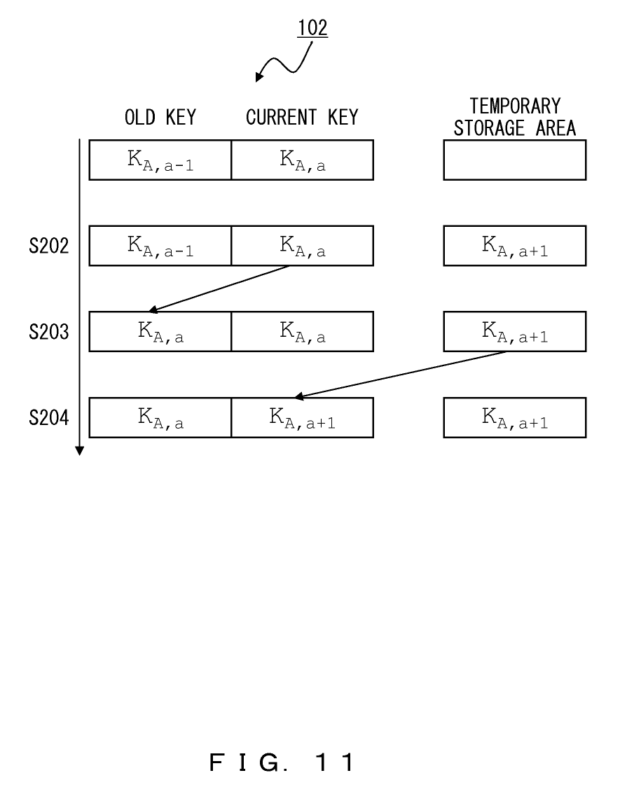

FIG. 10 is a flowchart of the cryptographic key updating process by the communication device according to the first embodiment. FIG. 11 is an explanatory view of a schematic diagram of an example of the transition of the data relating to the cryptographic key updating process. FIG. 11 is an explanatory view of the case as a concrete example in which the current key is a cryptographic key K_{A,a} in the communication device 100A.

In step S201, the key management unit 101 waits for the time when the cryptographic key is to be updated. When the key management unit 101 judges that it is time to update the cryptographic key, control is passed to step S202.

For example, when the interval of updating the cryptographic key is set in advance in the timer IC 204, the timer IC 204 may output an interrupt signal at an interval of updating the cryptographic key. Then, the key management unit 101 realized by the MPU 201 or the tamper resistant PIC microcomputer 205 may recognize the transfer of control from step S201 to S202 when the interrupt signal is detected.

In step S202, the key management unit 101 generates a new cryptographic key and stores it in a temporary storage area on the memory 104. For example, as exemplified in FIG. 11, assume that the current key stored in the key storage unit 102 is the cryptographic key K_{A,a} in the a-th generation and the old key is the cryptographic key K_{A,a-1} in the (a−1)-th generation in the communication device 100A. Then, the key management unit 101 generates a new cryptographic key K_{A,a+1} in the next (a+1)-th generation and stores it in the temporary storage area in step S202.

Then, in the next step S203, the key management unit 101 stores the current key stored by the key storage unit 102 as an old key. In the example in FIG. 11, the key management unit 101 copies the current key K_{A,a} to the field of the old key in the key storage unit 102.

Furthermore, in the next step S204, the key management unit 101 stores the newly generated cryptographic key as a current key in the key storage unit 102. In the example in FIG. 11, the key management unit 101 copies the new cryptographic key K_{A,a+1} stored in the temporary storage area in the field of the current key of the key storage unit 102. As a result, the key storage unit 102 stores the new cryptographic key K_{A,a+1} as the current key, and the cryptographic key K_{A,a} which has been the current key immediately before is stored as an old key.

Then, after performing the process in step S204, control is passed to step S201.

When the communication device 100 establishes a cryptographic key by key transport with another communication device 100, the communication device 100 transports the generated new cryptographic key to the other communication device 100 after steps S202, S203, or S204. Since the time taken for key transport is longer than the time taken for the update of the key storage unit 102 in the communication device 100, the communication device 100 may transport the new cryptographic key before the current key in the key storage unit 102 is updated in step S204 (for example, immediately after step S202).

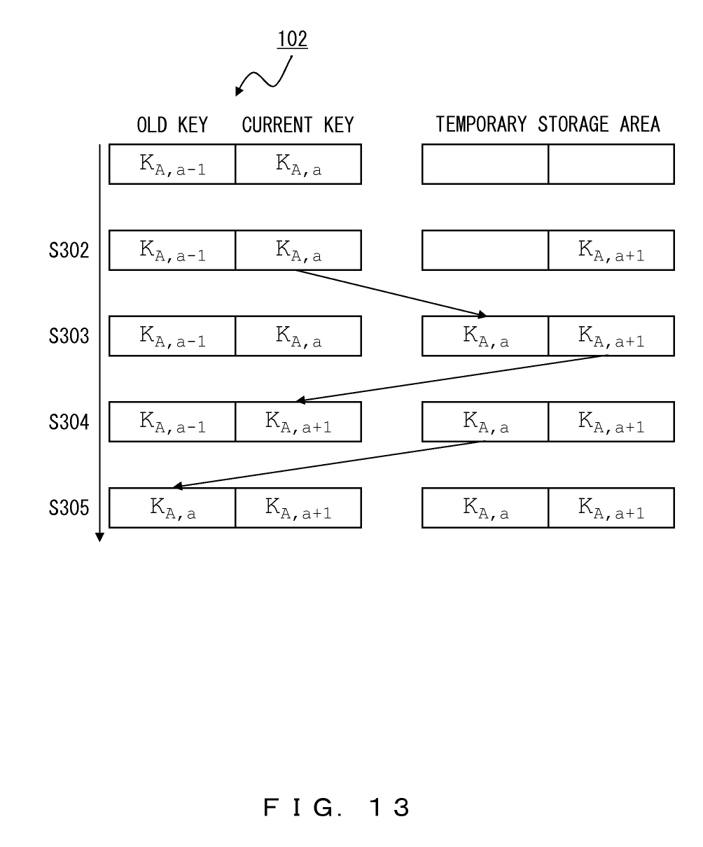

The cryptographic key updating process in FIG. 10 may be varied as illustrated in FIG. 12 in order to reduce the frequency of performing the error processing in step S112 in FIG. 7. In the description below, the flow of the varied cryptographic key updating process is first described with reference to FIGS. 12 and 13, and then the merits are described.

FIG. 12 is a flowchart of a variation example of the cryptographic key updating process. FIG. 13 is an explanatory view of a schematic diagram of an example of the transition of the data relating to a modified cryptographic key updating process varied as illustrated in FIG. 12. Like FIG. 11, FIG. 13 is an explanatory view as a concrete example of the case in which the current key is the cryptographic key K_{A,a} in the a-th generation in the communication device 100A.

In step S301, the key management unit 101 waits for the time when the cryptographic key is to be updated. When the key management unit 101 judges that it is tome to update the cryptographic key, control is passed to step S302. That is, step S301 is similar to step S201.

In step S302, the key management unit 101 generates a new cryptographic key and stores it in a temporary storage area on the memory 104. For example, as exemplified in FIG. 13, assume that the current key stored in the key storage unit 102 is the cryptographic key K_{A,a} in the a-th generation and the old key is the cryptographic key K_{A,a-1} in the (a−1)-th generation. Then, in step S302, the key management unit 101 generates a new cryptographic key K_{A,a+1} in the next (a+1)-th generation and stores it in a temporary storage area.

Then, in next step S303, the key management unit 101 copies the current key to the temporary storage area on the memory 104 (to be correct, another temporary storage area than the area where the new cryptographic key is stored in step S302). In the example in FIG. 13, the key management unit 101 copies the current key K_{A,a} to the temporary storage area on the memory 104.

Furthermore, in the next step S304, the key management unit 101 stores the generated new cryptographic key as a current key in the key storage unit 102. In the example in FIG. 13, the key management unit 101 copies the new cryptographic key K_{A,a+1} stored in the temporary storage area to the field of the current key of the key storage unit 102.

Then, in the next step S305, the key management unit 101 stores the current key copied to the temporary storage area in step S303 as an old key in the key storage unit 102. In the example in FIG. 13, the key management unit 101 copies the cryptographic key K_{A,a} stored in the temporary storage area to the field of the old key of the key storage unit 102. As a result, the key storage unit 102 stores a new cryptographic key K_{A,a+1} as a current key, and stores as an old key the cryptographic key K_{A,a} which has been the current key immediately before.

Then, after the execution of the process in step S305, control is returned to step S301. When the communication device 100 establishes a cryptographic key by the key transport with another communication device 100, the communication device 100 transports the generated new cryptographic key to the other communication device 100 after step S302, S303, S304, or S305. In the cryptographic key updating process in FIG. 12, the execution order of steps S302 and S303 may be reverse, or the processes in steps S302 and S303 are executed in parallel.

The cryptographic key updating process modified as illustrated in FIG. 12 is designed to obtain correct plaintext data by the decryption using an old key as much as possible although the key storage unit 102 is referred to during the update of the key storage unit 102. That is, the cryptographic key updating process in FIG. 12 is designed not to enter the state in which the old key read when the decryption unit 106 performs again the decryption after the decryption and the re-encryption by the current key K_{A,a} before the update is the same as the cryptographic key K_{A,a} used at the first decryption. Concretely, the cryptographic key updating process is varied in FIG. 2 so that the step S305 in which the old key K_{A,a-1} is updated in a series of steps S302 through S305 for update of the key storage unit 102 may be the last.

Depending on the embodiment, the key management unit 101 may block the reference from the decryption unit 106 or the re-encryption unit 108 to the key storage unit 102 during the execution in steps S202 through S204 or steps S302 through S305.

Then, the second embodiment is described with reference to FIGS. 14 through 20. In the second embodiment, two types of cryptographic keys are available. Then, according to the first embodiment, the method of establishing a key between the communication devices 100 is arbitrary as described above, but a key is established in two different methods for two types of cryptographic keys according to the second embodiment.

Concretely, the first type of cryptographic key is established between the communication devices by generating the key according to the same algorithm between the communication devices, and is used in encrypting and decrypting as shared among a plurality of communication devices. In the description below, the first type of cryptographic key is hereafter referred to as a “shared key”. Then, the second type of cryptographic key is inherent to each communication device, and hereafter referred to as an “access key”. An access key is established between the communication devices by key transport. In the second embodiment, the access key is used in encrypting application data, and the shared key is used in encrypting for a transport of the access key.

In the description below, for convenience of explanation, the access key generated by a communication device itself is hereafter referred to as an “internally-originated access key”, and the access key transported from another communication device is hereafter referred to as an “externally-originated access key”.

For example, when the first and second communication devices mutually transport the access key to each other, the access key generated by the first communication device is an internally-originated access key for the first communication device, but an externally-originated access key for the second communication device. Similarly, the access key generated by the second communication device is an externally-originated access key for the first communication device, but an internally-originated access key for the second communication device.

FIG. 14 is a block diagram of the configuration of the communication device according to a second embodiment. A communication device 400 may also be realized by various types of hardware illustrated in FIG. 4, for example.

The communication device 400 includes a key management unit 401. The key management unit 401 includes a shared key management unit 402, an internally-originated access key management unit (hereafter referred to as an I-key management unit) 403, and an externally-originated access key management unit (hereafter referred to as an E-key management unit) 404.

The shared key management unit 402 is a concrete example of the key management unit 101 according to the first embodiment, and has apart of the function of the key recognition unit 112. Concretely, the shared key management unit 402 performs the process of obtaining a unique value for time, thereby operating as a key generation unit for generating a shared key as a type of cryptographic key, and recognizes a shared key as a cryptographic key.

The I-key management unit 403 is one of the concrete examples of the key management unit 101. That is, the I-key management unit 403 also operates as a key generation unit for generating as a type of cryptographic key an internally-originated access key as a cryptographic key specific to the communication device 400 itself.

Then, the E-key management unit 404 is one of the concrete examples of the key recognition unit 112, and manages the externally-originated access key as associated with another communication device 400.

In addition, the I-key management unit 403 is one of the concrete examples of the plaintext processing unit 109, and generates the transmission data 115 of plaintext including an internally-originated access key. Then, the E-key management unit 404 is one of the concrete examples of the plaintext processing unit 109, and extracts an externally-originated access key by processing the received data 114 of plaintext including an externally-originated access key.

The shared key management unit 402 and the I-key management unit 403 may be realized by the MPU 201 in FIG. 4, or realized by the tamper resistant PIC microcomputer 205. The shared key management unit 402 and the I-key management unit 403 may receive from a clock 425 described later and realized by, for example, the timer IC 204 in FIG. 4 an interrupt signal for each update interval of the cryptographic key. The E-key management unit 404 may be realized by the MPU 201.

The communication device 400 also includes a key storage unit 405. The key storage unit 405 includes a shared key storage unit 406, an internally-originated access key storage unit (hereafter referred to as an I-key storage unit) 407, and an externally-originated access key storage unit (hereafter referred to as an E-key storage unit) 408.

The shared key storage unit 406 has the function of the key storage unit 102 for storing a decryption key according to the first embodiment, and a part of the function of the key recognition unit 112 (that is, the function of recognizing a cryptographic key). In addition, the I-key storage unit 407 has the function of the key storage unit 102 for storing a decryption key. Then, the E-key storage unit 408 has a part of the function of the key recognition unit 112 (that is, the function of recognizing a cryptographic key).

Furthermore, each component of the key storage unit 405 may be realized by the DRAM 206, or realized by RAM in the tamper resistant PIC microcomputer 205. Otherwise, when the communication device 400 includes tamper resistant memory as hardware, each component in the key storage unit 405 may be realized by the tamper resistant memory.

Additionally, the communication device 400 includes a directive unit 409. The directive unit 409 is one of the concrete examples of the directive unit 103. That is, the directive unit 409 recognizes which cryptographic key is to be used, a decryption key or a re-encryption key. The directive unit 409 may be realized by the MPU 201.

The communication device 400 includes the memory 104 and the receiver 105 according to the first embodiment, and similar memory 410 and receiver 411. The memory 410 is realized by the DRAM 206, and the receiver 411 is realized by at least one of the wired processing unit 202 and the wireless processing unit 203, and the MPU 201.

Then, the communication device 400 includes a decryption unit 412. The decryption unit 412 includes a received data decryption unit 413 and an externally-originated access key decryption unit (hereafter referred to as an E-key decryption unit) 414 corresponding to concrete examples of the decryption unit 106 according to the first embodiment. Each component of the decryption unit 412 may be realized by the MPU 201 for executing a program and by a dedicated decryption circuit.

In addition, one decryption circuit may physically function as the received data decryption unit 413 depending on the input signal, and may function as a received data decryption unit 413. Similarly, depending on the argument, a program module of the same decryption algorithm may allow the MPU 201 to function as the received data decryption unit 413, or may allow the MPU 201 to function as the E-key decryption unit 414.

Furthermore, the communication device 400 includes a judging unit 415. The judging unit 415 includes an externally-originated access key judging unit (hereafter referred to as an E-key judging unit) 416 and a received data judging unit 417 corresponding to the concrete example of the judgment unit 107 according to the first embodiment. Each component of the judging unit 415 is realized by, for example, the MPU 201.

Furthermore, the communication device 400 includes an encryption unit 418. The encryption unit 418 includes an externally-originated access key re-encryption unit (hereafter referred to as an E-key re-encryption unit) 419 and a received data re-encryption unit 420 corresponding to the concrete example of the re-encryption unit 108 according to the first embodiment. Furthermore, the encryption unit 418 includes a transmission data encryption unit 421 and an internally-originated access key encryption unit (hereafter referred to as an I-key encryption unit) 422 having the function of encryption by the encryption unit 111 according to the first embodiment. Each component of the encryption unit 418 may be realized by the MPU 201 for executing a program, and may be realized by a dedicated encryption circuit.

Furthermore, one encrypting circuit physically may function as one of the E-key re-encryption unit 419, the received data re-encryption unit 420, the transmission data encryption unit 421, and the I-key encryption unit 422 according to an input signal. Similarly, a program module of the same encrypting algorithm may allow the MPU 201 to function as one of the components in the encryption unit 418 depending on the argument.

Then, the communication device 400 includes a data processing unit 423 corresponding to one of the concrete examples of the plaintext processing unit 109 according to the first embodiment. The data processing unit 423 is also a concrete example of the plaintext processing unit 109 for processing the received data 114 whose payload is plaintext, and is a concrete example of the plaintext processing unit 109 as a data generation unit for generating the transmission data 115 of plaintext to be transmitted to the communication device 100. The data processing unit 423 may be realized by the MPU 201.

Furthermore, the communication device 400 includes a transmitter 424 having the function similar to that of the transmitter 113 according to the first embodiment. The transmitter 424 is realized by at least one of the wired processing unit 202 and the wireless processing unit 203 and the MPU 201. According to the second embodiment, the I-key management unit 403, the I-key encryption unit 422, and the transmitter 424 cooperate to operate as an internally-originated access key transporting unit for notifying another communication device 400 of the internally-originated access key. The internally-originated access key transport unit is an example of the notifying unit for notifying another communication device of the cryptographic key.

Then, the communication device 400 also includes the clock 425. The clock 425 may be realized by the timer IC 204. Otherwise, the MPU 201 may function as the clock 425 according to the clock signal.

FIG. 14 also illustrates received data 426, transmission data 427, externally-originated access key transport data (hereafter referred to as E-key transport data) 428, and internally-originated access key transport data (hereafter referred to as I-key transport data) 429 to be stored in the memory 410. Also in the second embodiment, in the encrypting and decrypting operations, the similar overwrite on the storage area as in the first embodiment is performed. Therefore, the payload of each piece of data in the memory 410 may be correct plaintext data, ciphertext data, or decrypted data decrypted by a cryptographic key different from the key used in the encryption.

As described above, each component of the communication device 400 according to the second embodiment has the function of the same as or similar to the function of each component of the communication device 100 according to the first embodiment. Then, the detailed operation of each component of the communication device 400 is omitted here, and is described later with reference to the corresponding flowchart. The communication device 400 in FIG. 14 may be used instead of the communication devices 100A through 100L in the ad hoc network 140 in FIG. 2, or the gateway device 120 may includes each component of the communication device 400.

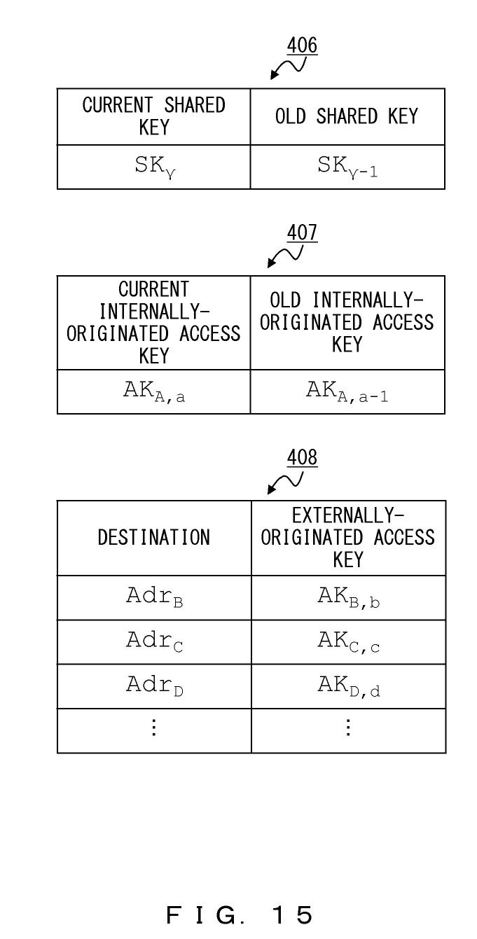

FIG. 15 is an example of the data stored in the communication device according to the second embodiment.

FIG. 15 exemplifies the data in the shared key storage unit 406, the I-key storage unit 407, and the E-key storage unit 408 in the communication device 400.

The shared key storage unit 406 illustrated in FIG. 15 stores as a current shared key the shared key SK_{γ} of the latest γ-th generation generated by the shared key management unit 402. Furthermore, the shared key storage unit 406 stores as a shared key the shared key SK_{γ-1} of the (γ−1)-th generation generated before by the shared key management unit 402.

The current shared key is one of the concrete examples of the current keys according to the first embodiment, and the old shared key is one of the concrete examples of the old keys according to the first embodiment. The directive unit 409 selects one of the current shared key and the old shared key as a “selected shared key”.

Then, the I-key storage unit 407 illustrated in FIG. 15 stores the internally-originated access key K_{A,a} of the latest a-th generation generated by the I-key management unit 403 as a current internally-originated access key. Furthermore, the I-key storage unit 407 stores the internally-originated access key K_{A,a-1} of the (a−1)-th generation generated before by the I-key management unit 403 as an old internally-originated access key.

The current internally-originated access key is one of the concrete examples of the current key according to the first embodiment, and the old internally-originated access key is one of the concrete examples of the old key according to the first embodiment. The directive unit 409 selects one of the current internally-originated access key and the old internally-originated access key as a “selected internally-originated access key”.

Then, the E-key storage unit 408 illustrated in FIG. 15 stores the access key of another communication device 400 which has established a key with the local communication device 400 as associated with the address. The address is an example of the identification information for uniquely identifying the other communication device 400. The second embodiment as well as the first embodiment is applicable to various types of communication protocols. Therefore, the layer of the address stored by the E-key storage unit 408 may be manifold. For example, a MAC address, an IP address, etc. are available.

Concretely, in the example in FIG. 15, the E-key storage unit 408 stores the latest externally-originated access key AK_{B,b} transported from another communication device 400 assigned the address Adr_{B} as associated with the address Adr_{B}. Similarly, the E-key storage unit 408 stores the latest externally-originated access key AK_{C,c} transported from another communication device 400 assigned the address Adr_{C} as associated with the address Adr_{c}. Furthermore, the E-key storage unit 408 stores the latest externally-originated access key AK_{D,d} transported from another communication device 400 assigned the address Adr_{D} as associated with the address Adr_{D}.

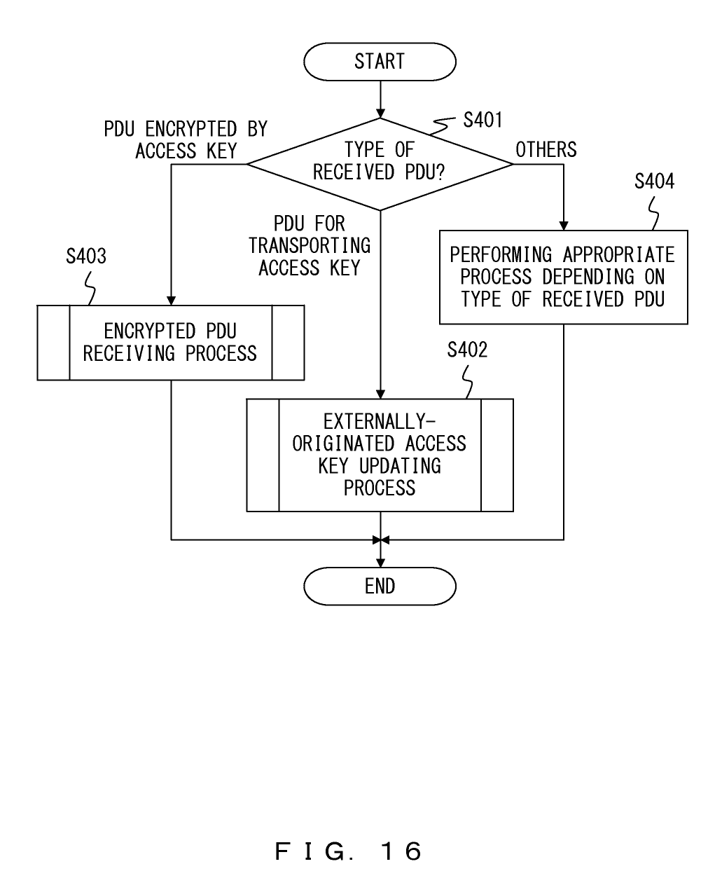

FIG. 16 is a flowchart of the receiving process performed when the communication device according to the second embodiment receives data. Upon receipt of a PDU, the receiver 411 stores the data of the received PDU in the memory 410. Therefore, the data of the received PDU is stored in the memory 410 when the process in FIG. 16 is started.

Depending on the communication protocol, a PDU addressed to another communication device 400 may be physically received. However, in this case, the receiver 411 judges from the header of the received PDU before starting the receiving process in FIG. 16 whether or not the destination is the communication device 400 itself. Then, the receiver 411 discards the data of the received PDU when the destination is not the communication device 400 itself, and starts the receiving process in FIG. 16 is started when the destination is the communication device 400 itself.

In step S401, the receiver 411 judges the type of the received PDU with reference to the memory 410. In the second embodiment, the header includes the field indicating the type of the PDU. However, the receiver 411 may judge the type of PDU with reference to the value of the field indicating the type.

When the received PDU is a PDU for transporting an access key, the data of the PDU for transporting the access key received by the communication device 400 is concretely the E-key transport data 428 in FIG. 14. Therefore, in this case, the receiver 411 instructs the E-key decryption unit 414 to decrypt the payload of the E-key transport data 428, and control is passed to step S402.

The PDU for transporting an access key is a type of the ciphertext PDU 307 in FIG. 6. The body 305 encrypted in the PDU for transporting an access key is the data obtained by encrypting the data including the internally-originated access key for the communication device 400 for transmitting the ciphertext PDU 307 using the shared key.

Otherwise, when the received PDU is to be encrypted by an access key, the data of the PDU received by the communication device 400 concretely refers to the received data 426 in FIG. 14. Therefore, in this case, the receiver 411 instructs the received data decryption unit 413 to decrypt the payload of the received data 426, and control is passed to step S403.

In addition, when the PDU does not refer to the above-mentioned two types, control is passed to step S404.

For example, in the ad hoc network 140 in FIG. 2, a plurality of communication devices 400 may be used instead of the communication devices 100A through 100L, and the communication devices 400 may communicate the PDU for control of time synchronization using a cryptographic key fixed in advance in the ad hoc network 140. Otherwise, the communication devices 400 may communicate a specific type of PDU without encryption. Thus, the PDU whose payload has been encrypted by a prefixed cryptographic key or the PDU whose payload is clear text is received, control is passed to step S404.

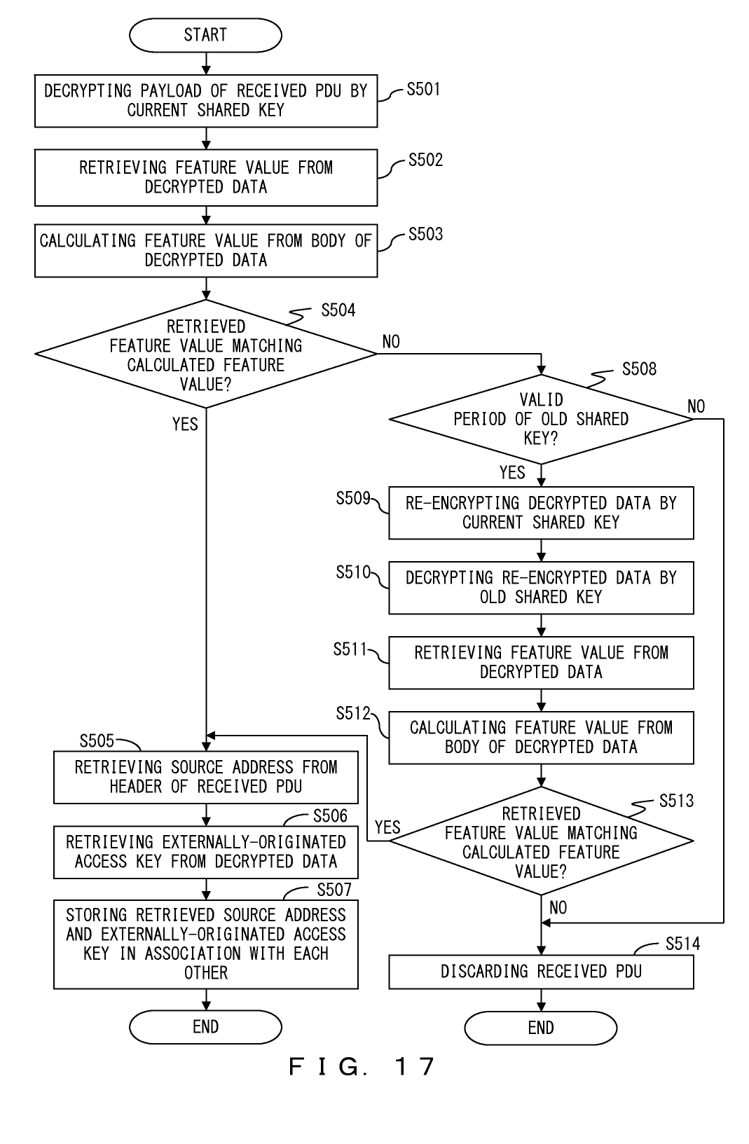

In step S402, the communication device 400 performs the externally-originated access key updating process illustrated in FIG. 17, thereby terminating the receiving process in FIG. 16.

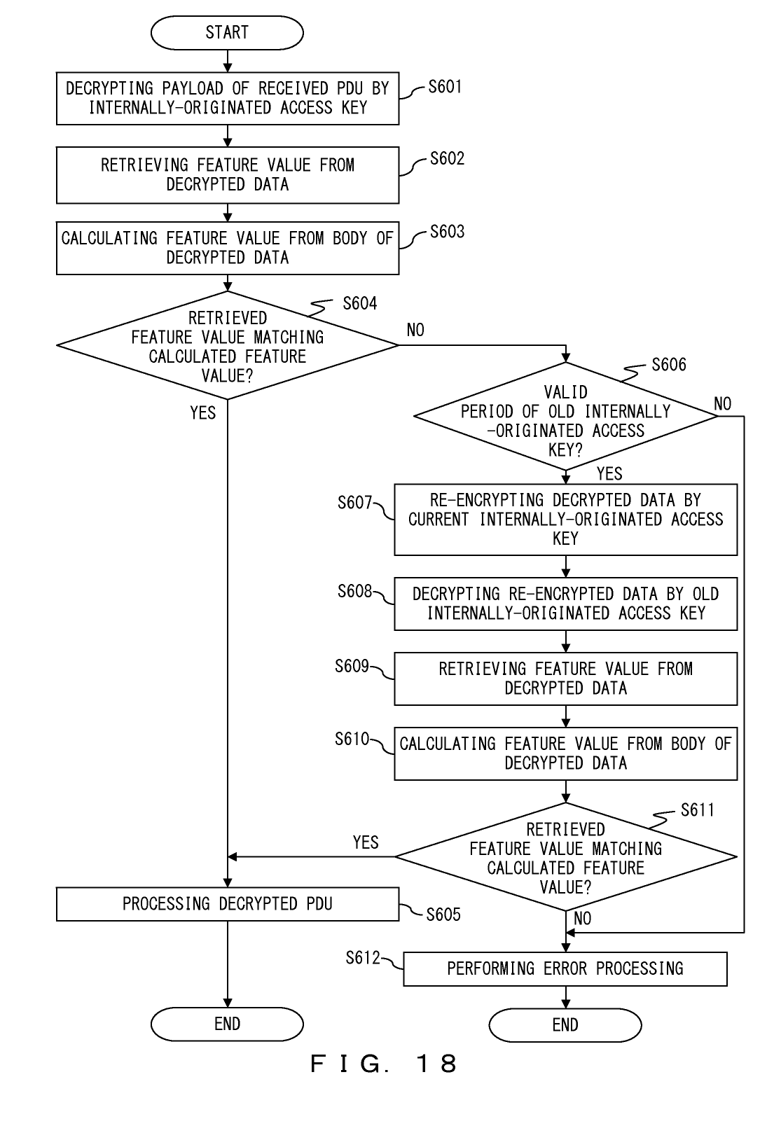

In step S403, the communication device 400 performs the encrypted PDU receiving process in FIG. 18, thereby terminating the receiving process in FIG. 16.

In step S404, the communication device 400 performs an appropriate process depending on the type of the received PDU. When the process depending on the type of PDU is terminated, the receiving process in FIG. 16 is also terminated.

The subject of the process, the details of the process, and the type of PDU in the process in step S404 are arbitrary depending on the embodiments. For example, when the PDU for controlling the time synchronization exemplified with respect to step S401 is received, the controlling PDU processing unit not illustrated in the attached drawings may perform the time synchronizing process for adjusting the clock 425 as necessary.

FIG. 17 is a flowchart of the externally-originated access key updating process by the communication device according to the second embodiment. In the process in FIG. 17, the descriptions of the points similar to those in the receiving process in FIG. 7 according to the first embodiment are appropriately omitted.

In step S501, the E-key decryption unit 414 decrypts the payload of the E-key transport data 428 at the instruction from the receiver 411. Concretely, the E-key decryption unit 414 first acquires from the directive unit 409 the information as to which is selected as a selected shared key, the current shared key or the old shared key. Then, the E-key decryption unit 414 reads the selected shared key from the shared key storage unit 406, and decrypts the payload of the E-key transport data 428 using the selected shared key.

The directive unit 409 selects the current shared key as the selected shared key in the initial state in which the communication device 400 is powered up. Although the process in FIG. 17 is performed each time the PDU for transporting an access key is received, the directive unit 409 selects the current shared key as a selected shared key when the process in FIG. 17 is terminated as described later relating to steps S504, S508, and S513. Therefore, at the time point in step S501, the selected shared key is the current shared key.

Therefore, in step S501, the E-key decryption unit 414 obtains the information from the directive unit 409 that the selected shared key is the current shared key. Then, the E-key decryption unit 414 reads the current shared key from the shared key storage unit 406, and decrypts the payload of the E-key transport data 428 using the current shared key.

When the decryption in step S501 is performed, the E-key decryption unit 414 overwrites the ciphertext of the payload of the E-key transport data 428 with the decrypted data as with the decryption unit 106 according to the first embodiment. By the overwrite, the excess consumption of the storage area is suppressed.

Upon completion of the decryption, the E-key decryption unit 414 notifies the E-key judging unit 416 of the completion of the decryption. Then, control is passed to step S502.

In step S502, the E-key judging unit 416 which has received the notification from the E-key decryption unit 414 retrieves the feature value from the data decrypted by the E-key decryption unit 414.

In the next step S503, the E-key judging unit 416 calculates the feature value from the body of the data decrypted by the E-key decryption unit 414. The process in steps S502 and S503 may be performed in the reverse order or in parallel.

Then, in step S504, the E-key judging unit 416 judges whether or not the retrieved feature value matches the calculated feature value.

When the two feature values match each other, the E-key judging unit 416 judges that the payload of the E-key transport data 428 decrypted in step S501 and stored in the memory 410 is correct plaintext data. In this case, the E-key judging unit 416 directs the E-key management unit 404 to extract the transported externally-originated access key and enter it in the E-key storage unit 408 using the E-key transport data 428 on the memory 410.

When the two feature values match each other, the E-key judging unit 416 may direct the directive unit 409 to reset the selected shared key in preparation for the next reception of the PDU for transporting an access key, and the directive unit 409 may select the current shared key again as a selected shared key. As in step S105 in FIG. 7, the explicit reset may be omitted. When the two feature values match each other, control is passed to step S505.

On the other hand, when the two feature values do not match each other, the E-key judging unit 416 judges that the payload of the E-key transport data 428 decrypted in step S501 and stored on the memory 410 is invalid. Then, control is passed to step S508.

In steps S505 through S507, the E-key management unit 404 refers to the E-key transport data 428 decrypted by the E-key decryption unit 414, extracts the transported externally-originated access key, and enters it in the E-key storage unit 408. The E-key management unit 404 in steps S505 through S507 operates as a type of plaintext processing unit 109 according to the first embodiment.

Concretely, the E-key management unit 404 in step S505 refers to the memory 410 and retrieves the source address from the header of the received PDU. That is, the E-key management unit 404 retrieves the source address included in the header 302 from the E-key transport data 428 stored in the memory 410 in the state of the decrypted PDU 310 in FIG. 6.

Then, in the next step S506, the E-key management unit 404 retrieves an externally-originated access key from the data decrypted by the E-key decryption unit 414. That is, the E-key management unit 404 retrieves the externally-originated access key included in the decrypted body 308 from the E-key transport data 428 stored on the memory 410 in the state of the decrypted PDU 310 in FIG. 6. The processes in steps S505 and S506 may be performed in the reverse order or in parallel.

Then, in step S507, the E-key management unit 404 associates the source address retrieved in step S505 with the externally-originated access key retrieved in step S506, and stores the resultant key in the E-key storage unit 408.

Concretely, the E-key management unit 404 searches the E-key storage unit 408 using the retrieved source address as a search key. If an entry having the address matching the retrieved source address is detected as a result of the search, the E-key management unit 404 overwrites the externally-originated access key in the detected entry with the externally-originated access key retrieved in step S506. On the other hand, unless an entry having the address matching the retrieved source address is detected, the E-key management unit 404 adds a new entry for associating the retrieved source address with the retrieved externally-originated access key to the E-key storage unit 408, thereby terminating the process in FIG. 17.

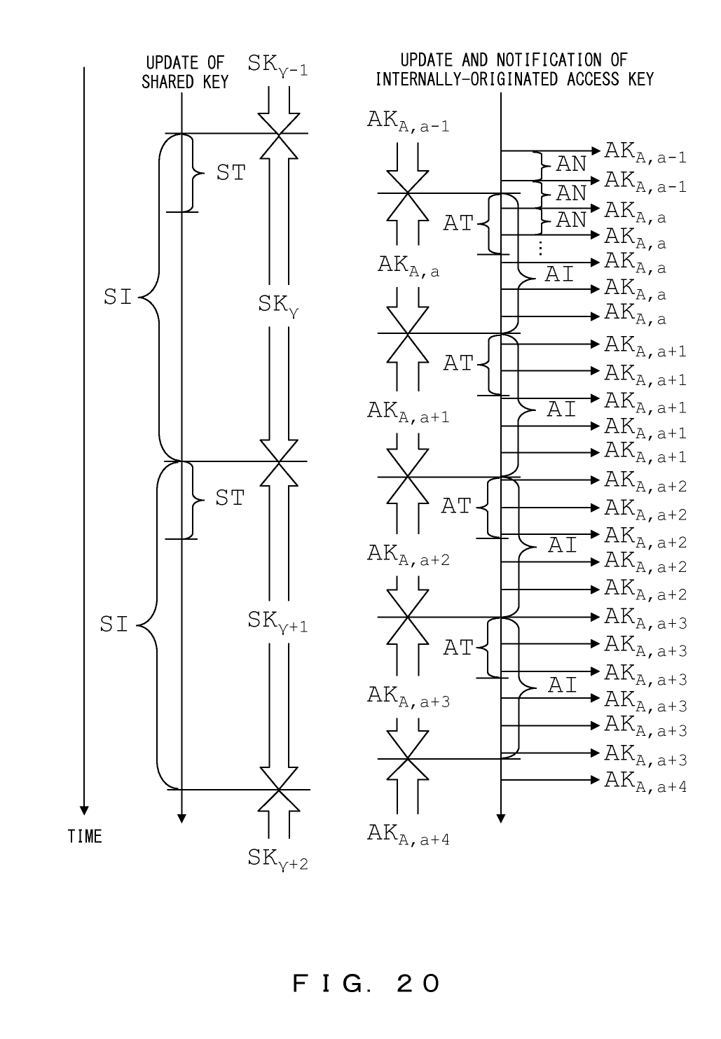

If the two feature values do not match each other in step S504, the E-key judging unit 416 judges in step 508 whether or not the current time is in a valid period of the old shared key. The current time being in the valid period in the second embodiment refers the elapsed time from the latest update of the shared key to the current time being in a specified allowed time (“ST” in FIG. 20 described later).

In the second embodiment, each communication device 400 in the network updates the respective shared key at the same specified interval (“SI” in FIG. 20 described later). The allowed time ST used as a threshold in step S504 is a time shorter than the update interval SI. A concrete method of the E-key judging unit 416 recognizing the valid period of the old shared key may be manifold depending on the embodiments, and may, for example, recognizing the valid period of an old shared key by the E-key judging unit 416 as follows.

For example, the clock 425 may output a shared key update timing signal as a trigger of updating a shared key to the shared key management unit 402 each time the update interval SI of the shared key passes. The shared key update timing signal may be, for example, an interrupt signal.

Furthermore, the clock 425 may assert an old shared key validity signal indicating that the old shared key is valid only during the allowed time ST from the output of the shared key update timing signal. That is, the clock 425 may negate the old shared key validity signal during the period from the lapse of the allowed time ST to the next output of the shared key update timing signal. Then, the E-key judging unit 416 may recognize from the old shared key validity signal output from the clock 425 whether or not the current time is in the valid period of the old shared key.

Otherwise, the E-key judging unit 416 may acquire the current time from the clock 425, and calculate the elapsed time from the latest update time of the shared key to the current time using the reference time for update of the shared key, the update interval SI of the shared key, and the current time. Then, the E-key judging unit 416 may compare the calculated elapsed time with the allowed time ST as the threshold, and judge that the current time is in the valid period of the old shared key if the calculated elapsed time is in the allowed time ST. Regardless of the example, the judgment by the comparison with the threshold may be made as to whether a value is equal to or smaller than the threshold or it exceeds the threshold, or may be as to whether it is smaller than the threshold or it is equal to or exceeds the threshold. That is, the judging method may be appropriate decided.

When the current time is in the valid period of the old shared key, the E-key judging unit 416 instructs the E-key re-encryption unit 419 to re-encrypt the payload of the E-key transport data 428 and restore it to the original state. Then, control is passed to step S509.

On the other hand, when the current time runs over the valid period, the E-key judging unit 416 judges that the PDU for transporting an access key as a trigger of the process in FIG. 17 is invalid, and control is passed to step S514.

When control is passed from step S508 to step S514, the selected shared key remains a current shared key. That is, depending on the embodiments, a selected shared key may be implicitly reset.

In step S509, the E-key re-encryption unit 419 re-encrypts the data decrypted by the E-key decryption unit 414. Concretely, the E-key re-encryption unit 419 first acquires from the directive unit 409 the information that the selected shared key is the current shared key. Then, the E-key re-encryption unit 419 reads the current shared key from the shared key storage unit 406, and encrypts the payload of the E-key transport data 428 using the current shared key.

As with the re-encryption unit 108 according to the first embodiment, the E-key re-encryption unit 419 overwrites the payload of the E-key transport data 428 with the encrypted data when the encryption is performed. By the overwrite, the excess consumption of a storage area is suppressed.

Then, upon completion of the encryption, the E-key re-encryption unit 419 notifies the directive unit 409 of the completion of the encryption. Then, the directive unit 409 re-selects as a selected shared key the old shared key which is a shared key different from the selected shared key being selected currently, and directs the E-key decryption unit 414 to decrypt the payload of the E-key transport data 428.

Then, the E-key decryption unit 414 decrypts the data re-encrypted by the E-key re-encryption unit 419 by the old shared key in step S510. Concretely, the E-key decryption unit 414 first acquires the information from the directive unit 409 that the selected shared key is the old shared key. Then, the E-key decryption unit 414 reads from the shared key storage unit 406 the old shared key, and decrypts the payload of the E-key transport data 428 using the old shared key.

In the decryption in step SS510, the E-key decryption unit 414 overwrites the ciphertext of the payload of the E-key transport data 428 with the decrypted data as in step S501. By the overwrite, the excess consumption of the storage area is suppressed.

Upon completion of the decryption, the E-key decryption unit 414 notifies the E-key judging unit 416 of the completion of the decryption. Then, control is passed to step S511.

In step S511, the E-key judging unit 416 retrieves a feature value from the data decrypted by the E-key decryption unit 414.

In addition, in the next step S512, the E-key judging unit 416 calculates the feature value from the body of the data decrypted by the E-key decryption unit 414 as in step S503. The processes in steps S511 and S512 may be performed in the reverse order or in parallel.

In step S513, the E-key judging unit 416 judges whether or not the retrieved feature value matches the calculated feature value.

When the two feature values match each other, the E-key judging unit 416 judges that the payload of the E-key transport data 428 decrypted in step S510 and stored on the memory 410 is valid plaintext data. In this case, the E-key judging unit 416 instructs the E-key management unit 404 to perform the process of entering the transported externally-originated access key in the E-key storage unit 408 using the E-key transport data 428 on the memory 410.

When the two feature values match each other, the E-key judging unit 416 further instructs the directive unit 409 to reset the selected shared key in preparation for the next reception of the PDU for transporting an access key. Then, the directive unit 409 re-selects the current shared key as a selected shared key. Therefore, the selected shared key at the time point after the PDU for transporting an access key is next received and before re-starting the process in FIG. 17 is a current key. If the selected shared key is re-selected as described above, control is passed to step S505.

On the other hand, when the two feature values do not match each other, the E-key judging unit 416 judges that the E-key transport data 428 decrypted in step S510 and stored on the memory 410 is invalid.

In the second embodiment, since the shared key storage unit 406 holds only the shared keys of two generations, that is, the current shared key and the current shared key, there is no more shared keys of other generations to be checked. Therefore, when the two feature values do not match each other, the E-key judging unit 416 instructs the directive unit 409 to reset the selected shared key in preparation for the next reception of the PDU for transporting an access key. Then, the directive unit 409 re-selects the current shared key as a selected shared key, and control is passed to step S514.

In addition, in step S514, the E-key judging unit 416 discards the received PDU. Concretely, for example, the E-key judging unit 416 may discard the received PDU by releasing the storage area of the E-key transport data 428 on the memory 410. After the discard, the process in FIG. 17 terminates.

FIG. 18 is a flowchart of the encrypted packet receiving process by the communication device according to the second embodiment. In the process in FIG. 18, the point similar to the receiving process in FIG. 7 according to the first embodiment is appropriately omitted.

In step S601, the received data decryption unit 413 decrypts the payload of the received data 426 at the instruction from the receiver 411. Concretely, the received data decryption unit 413 first acquires from the directive unit 409 the information as to which is selected as a selected internally-originated access key, the current internally-originated access key or the old internally-originated access key. Then, the received data decryption unit 413 reads the selected internally-originated access key from the I-key storage unit 407, and decrypts the payload of the received data 426 using the selected internally-originated access key.

In the initial state in which the communication device 400 is powered up, the directive unit 409 selects the current internally-originated access key as a selected internally-originated access key. The process in FIG. 18 is performed each time the PDU encrypted by an access key is received, but as described later with reference to steps S604, S606, and S611, the directive unit 409 selects the current internally-originated access key as a selected internally-originated access key when the process in FIG. 18 is terminated. Therefore, at the time point in step S601, the selected internally-originated access key is a current internally-originated access key.

Therefore, in step S601, the received data decryption unit 413 first acquires from the directive unit 409 the information that the selected internally-originated access key is a current internally-originated access key. Then, the received data decryption unit 413 reads the current internally-originated access key from the I-key storage unit 407, and decrypts the payload of the received data 426 using the current internally-originated access key.

In the decryption in step S601, the received data decryption unit 413 overwrites the S602, ciphertext of the payload of the received data 426 with the decrypted data as with the decryption unit 106 according to the first embodiment. By the overwrite, the excess consumption of the storage area is suppressed.

Upon completion of the decryption, the received data decryption unit 413 notifies the received data judging unit 417 of the completion of the decryption. Then, control is passed to step S602.

In step S602, upon receipt of the notification from the received data decryption unit 413, the received data judging unit 417 retrieves the feature value from the data decrypted by the received data decryption unit 413.

Then, in the next step S603, the received data judging unit 417 calculates the feature value from the body of the data decrypted by the received data decryption unit 413. The processes in steps S602 and S603 may be performed in the reverse order or in parallel.

Then, in step S604, the received data judging unit 417 judges whether or not the retrieved feature value matches the calculated feature value.

When the two feature values match each other, the received data judging unit 417 judges that the payload of the received data 426 decrypted in step S601 and stored on the memory 410 is valid plaintext data. In this case, the received data judging unit 417 instructs the data processing unit 423 to perform the process of the received data 426 on the memory 410.

When the two feature values match each other, the received data judging unit 417 may further instruct the directive unit 409 to reset the selected internally-originated access key in preparation for the next reception of the PDU encrypted by an access key. Then, the directive unit 409 may re-select the current internally-originated access key as a selected internally-originated access key. As in step S105 in FIG. 7, the above-mentioned explicit reset may be omitted. When the two feature values match each other, control is passed to step S605.

On the other hand, when the two feature values do not match each other, the received data judging unit 417 judges that the payload of the received data 426 decrypted in step S601 and stored on the memory 410 is invalid. Then, control is passed to step S606.

In step S605, the data processing unit 423 processes the PDU decrypted by the received data decryption unit 413. That is, the data processing unit 423 reads the data of the PDU whose payload is decrypted into valid plaintext and stored as the received data 426 on the memory 410, and performs an appropriate process. The process performed by the data processing unit 423 in step S605 is arbitrary, but may be the process exemplified relating to step S106 according to the first embodiment. When the process by the data processing unit 423 in step S605 is completed, the process in FIG. 18 also terminates.

When the two feature values do not match each other in step S604, the received data judging unit 417 judges in step S606 whether or not the current time is in the valid period of the old internally-originated access key. The current time being in the valid period of the old internally-originated access key according to the second embodiment refers to the elapsed time from the latest update of the internally-originated access key to the current time being in a specified allowed time (“AT” described later in FIG. 20).

In the second embodiment, the communication device 400 updates the internally-originated access key at a specified interval (“AI” described later in FIG. 20). The update interval AI of the access key is shorter than the update interval SI of the above-mentioned shared key. Although described later with reference to FIG. 20, it is preferable that the update interval AI of the access key is a half of or less than half of the update interval SI of the shared key for use of shared key in any generation twice or more in notifying the access key.

The allowed time AT used as a threshold in step S606 is a time shorter than the update interval AI of the internally-originated access key. The concrete method of the received data judging unit 417 recognizing the valid period of the old internally-originated access key may be manifold depending on the embodiments. Concretely, the received data judging unit 417 may recognize the valid period of the old internally-originated access key in the method similar to recognizing the valid period of the old shared key by the E-key judging unit 416 exemplified relating to step S508 in FIG. 17.

When the current time is in the valid period of the old internally-originated access key, the received data judging unit 417 instructs the received data re-encryption unit 420 to re-encrypting the payload of the received data 426 and returning it to the original state. Then, control is passed to step S607.

On the other hand, when the current time runs over the valid period of the old internally-originated access key, the received data judging unit 417 judges that the payload of the PDU as the trigger of the process in FIG. 18 is invalid. In this case, the received data judging unit 417 judges that any error has occurred, and control is passed to step S612. When control is passed from step S606 to step S612, the selected internally-originated access key remains a current internally-originated access key. Obviously, depending on the embodiments, the selected internally-originated access key may be explicitly reset.

In step S607, the received data re-encryption unit 420 re-encrypts the data decrypted by the received data decryption unit 413. Concretely, the received data re-encryption unit 420 acquires from the directive unit 409 the information that the selected internally-originated access key is a current internally-originated access key. Then, the received data re-encryption unit 420 reads the current internally-originated access key from the I-key storage unit 407, and encrypts the payload of the received data 426 using the current internally-originated access key.

As with the re-encryption unit 108, the received data re-encryption unit 420 overwrites the payload of the received data 426 with the encrypted data when the encrypting operation is performed. By the overwrite, the excess consumption of the storage area is suppressed.

Upon completion of the encryption, the received data re-encryption unit 420 notifies the directive unit 409 of the completion of the encryption. Then, the directive unit 409 instructs the received data decryption unit 413 to re-select as a selected internally-originated access key the old internally-originated access key as an internally-originated access key which is different from the selected internally-originated access key being currently selected, and decrypt the payload of the received data 426.

Then, in step S608, the received data decryption unit 413 decrypts the data re-encrypted by the received data re-encryption unit 420 by the old internally-originated access key. Concretely, the received data decryption unit 413 first acquires from the directive unit 409 the information that the selected internally-originated access key is the old originated access key. Then, the received data decryption unit 413 reads the old internally-originated access key from the I-key storage unit 407, and decrypts the payload of the received data 426 using the old internally-originated access key.

The received data decryption unit 413 overwrites the ciphertext of the payload of the received data 426 with the decrypted data as in step S601 when the decrypting operation is performed in step S608. By the overwrite, the excess consumption of the storage area is suppressed.

When completing the decryption, the received data decryption unit 413 notifies the received data judging unit 417 of the completion of the decryption. Then, control is passed to step S609.

In step S609, the received data judging unit 417 retrieves the feature value from the data decrypted by the received data decryption unit 413 as in step S602.

In the next step S610, the received data judging unit 417 calculates the feature value from the body of the data decrypted by the received data decryption unit 413 as in step S603. The processes in steps S609 and S610 may be performed in the reverse order or in parallel.

Then, in step S611, the received data judging unit 417 judges whether or not the retrieved feature value matches the calculated feature value.

When the two values match each other, the received data judging unit 417 judges that the payload of the received data 426 decrypted in step S608 and stored on the 410 is valid plaintext data. In this case, the received data judging unit 417 instructs the data processing unit 423 to perform the process of the received data 426 on the memory 410.

When the two feature values match each other, the received data judging unit 417 further instructs the directive unit 409 to reset the selected internally-originated access key in preparation for the next reception of the PDU encrypted by the access key. Then, the directive unit 409 re-selects the current internally-originated access key as a selected internally-originated access key. Therefore, the selected internally-originated access key at the time point when the PDU encrypted by an access key is next received and the process in FIG. 18 is started again is a current internally-originated access key. If the selected internally-originated access key is selected again as described above, control is passed to step S605.

On the other hand, when the two feature values do not match each other, the received data judging unit 417 judges that the payload of the received data 426 decrypted in step S608 and stored on the memory 410 is invalid.

In the second embodiment, since the I-key storage unit 407 holds only the internally-originated access keys of two generations, that is, the current internally-originated access key and the old internally-originated access key, there are no more internally-originated access keys of other generations to be checked. Therefore, when two feature values do not match each other, the received data judging unit 417 instructs the directive unit 409 to reset the selected internally-originated access key in preparation for the next reception of the PDU encrypted by the access key. Then, the directive unit 409 re-selects the current internally-originated access key as a selected internally-originated access key, and the control is passed to step S612.

In step S612, the received data judging unit 417 performs an appropriate process. Otherwise, the received data judging unit 417 may instructs an error processing unit not illustrated in the attached drawings to perform error processing. The concrete details of the error processing are arbitrary. For example, the error processing may be the process of releasing the storage area of the received data 426, or the process of requesting another source communication device 400 to re-transmit the PDU. After performing the error processing, the process in FIG. 18 also terminates.

As described above, as described above with reference to FIGS. 16 through 18, also in the second embodiment, the overwrite in the storage area on the memory 410 is performed in the decryption or re-encryption in a series of processes performed upon receipt of the PDU. Therefore, the second embodiment as well as the first embodiment has the saving effect of the storage area.

The communication device 400 also performs a process independent of the reception of the PDU. That is, the communication device 100 also transmits a PDU, updates a shared key, updates an internally-originated access key, and transports the internally-originated access key as described below.

Concretely, the data processing unit 423 generates the transmission data 427 of plaintext from the data transmitted to another device. Thus generated transmission data 427 is an example of the plaintext PDU 304 in FIG. 6. That is, the data processing unit 423 generates or acquires an appropriate body 301, sets an appropriate header 302, calculates the feature value 303 from the body 301, and generates the plaintext PDU 304 corresponding to the transmission data 427.

For example, when the communication device 400 is a node in the sensor network, the communication device 400 may include a sensor, or be connected to the sensor. Then, the data processing unit 423 may set the data output from the sensor in the body 301.

After completely generating the transmission data 427 of plaintext on the memory 410, the data processing unit 423 instructs the transmission data encryption unit 421 to encrypt the payload of the transmission data 427. Then, the transmission data encryption unit 421 recognizes the destination address (that is, the address of another communication device 400), and reads the externally-originated access key stored in the E-key storage unit 408 as associated with the recognized address.

As with the first embodiment, the transmission data encryption unit 421 may recognize the destination address by the data processing unit 423 explicitly notifying the transmission data encryption unit 421 of the destination of the transmission data 427. Otherwise, the transmission data encryption unit 421 reads the destination address from the header of the transmission data 427.

Then, the transmission data encryption unit 421 encrypts the payload of the transmission data 427 using the read externally-originated access key. In this case, as with the re-encryption by the E-key re-encryption unit 419 and the received data re-encryption unit 420, the transmission data encryption unit 421 also overwrites the same storage area on the memory 410. That is, the transmission data encryption unit 421 encrypts the payload of the plaintext of the transmission data 427, and overwrites the payload with the data of ciphertext obtained by the encryption. By the overwrite, the memory 410 may be efficiently used in transmitting the transmission data 427.

In addition, upon completion of the encrypting process, the transmission data encryption unit 421 instructs the transmitter 424 to transmit the transmission data 427. Then, the transmitter 424 transmits the transmission data 427.

Then, the update of the shared key in the communication device 400 is described below. The shared key management unit 402 of the communication device 400 updates the shared key on the shared key storage unit 406 as with the key management unit 101 according to the first embodiment which updates the cryptographic key on the key storage unit 102 by performing the process in FIG. 10 or 12. Therefore, although the detailed description is omitted here, the processes corresponding to the step S201 in FIG. 10 of step S301 in FIG. 12 are further described below.

In the second embodiment, the clock 425 may output the above-mentioned shared key update timing signal each time the update interval SI of the shared key passes. Then, when the shared key management unit 402 detects the shared key update timing signal, the unit may recognize that it is time to update a shared key. The shared key management unit 402 may acquire the current time from the clock 425, and judge whether or not it is time to update a shared key using the reference time in which the shared key is updated, the update interval SI of the shared key, and the current time.

Next, the update of the internally-originated access key in the communication device 400 is described below. The I-key management unit 403 of the communication device 400 updates the internally-originated access key on the I-key storage unit 407 as with the key management unit 101 in the first embodiment updating the cryptographic key on the key storage unit 102 by performing the process in FIG. 10 or 12. Therefore, the detailed description is omitted here, but the processes corresponding to the process in step S201 in FIG. 10 or step S301 in FIG. 12 are supplemented as follows.

In the second embodiment, the clock 425 may output the internally-originated access key update timing signal (for example, an interrupt signal) each time the update interval AI of the internally-originated access key passes. Upon detection of the internally-originated access key update timing signal, the I-key management unit 403 may recognize that it is time to update the internally-originated access key. Otherwise, the I-key management unit 403 may acquire the current time from the clock 425, and judge whether or not it is time to update the internally-originated access key using the reference time for update of the internally-originated access key, the update interval AI of the internally-originated access key, and the current time.

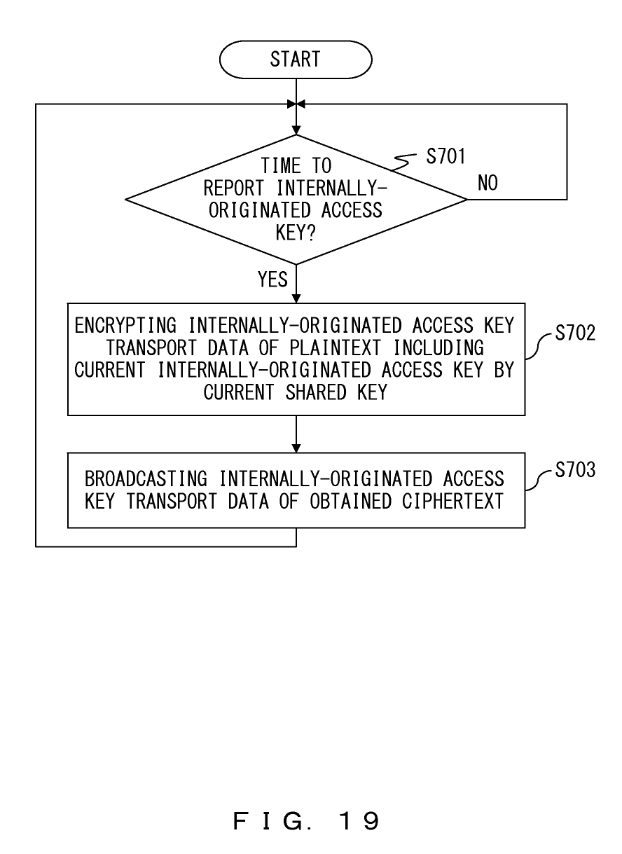

Next, the transport of an internally-originated access key is described with reference to FIG. 19. FIG. 19 is a flowchart of the internally-originated access key transporting process by the communication device according to the second embodiment.

The process in FIG. 19 is started after the 400 is powered up and at least the current internally-originated access key is set in the I-key storage unit 407. For example, when the communication device 400 is powered up, the I-key management unit 403 generates an internally-originated access key of the first generation, and stores the key as a current internally-originated access key in the I-key storage unit 407, and then the process in FIG. 19 may be started.

In step S701, the I-key management unit 403 waits for the time to issue a notification of the internally-originated access key. When the I-key management unit 403 judges that it is time to issue a notification of the internally-originated access key, control is passed to step S702.

In the second embodiment, the internally-originated access key is transported (that is, reported) to another communication device 400 at a specified notification interval (“AN” described later in FIG. 20). In the second embodiment, the notification interval AN of the access key is shorter than the update interval AI of the access key. For more detail, refer to the later description with reference to FIG. 20, but to issue a plurality of notifications for the internally-originated access key of each generation, it is preferable that the notification interval AN of the access key is a half or less of the update interval AI of the access key.

The concrete method of the I-key management unit 403 recognizing whether or not it is time to issue a notification of the internally-originated access key is arbitrary.

For example, the clock 425 may output an access key notification timing signal as a trigger of the notification of the access key each time the notification interval AN of the access key passes. The access key notification timing signal may be, for example, an interrupt signal. Upon detection of the access key notification timing signal from the clock 425, the I-key management unit 403 recognizes that it is tome to issue a notification of the internally-originated access key.

Otherwise, the I-key management unit 403 may acquire the current time from the clock 425, and judge whether or not it is time to issue a not of the internally-originated access key using the reference time for notification of the internally-originated access key, the notification interval AN of the access key, and the current time.

In step S702, the I-key management unit 403 generates the I-key transport data 429 of plaintext including the current internally-originated access key, and stores the data on the memory 410. The I-key management unit 403 in step S702 similarly functions as the plaintext processing unit 109 for generating the transmission data 115 according to the first embodiment.

The payload of the I-key transport data 429 generated in step S702 is still plaintext data. That is, the I-key transport data 429 is an example of the plaintext PDU 304 in FIG. 6, and the body 301 includes the current internally-originated access key. In addition, the I-key management unit 403 calculates the feature value 303 from the body 301, and appropriately sets the header 302. As described with reference to step S703, a broadcast address is set as the destination address in the header 302 according to the second embodiment.

When the I-key transport data 429 of plaintext is completely generated on the memory 410, the I-key management unit 403 instructs the I-key encryption unit 422 to encrypt a payload. Then, the I-key encryption unit 422 reads the current shared key from the shared key storage unit 406, and encrypts the payload of the I-key transport data 429 using the current shared key.

In this case, as with the re-encryption by the E-key re-encryption unit 419 and the received data re-encryption unit 420, the I-key encryption unit 422 also overwrites data in the same storage area on the memory 410. That is, the I-key encryption unit 422 encrypts the payload of plaintext of the I-key transport data 429, and overwrites the payload by the ciphertext data obtained by the encryption. By the overwrite, the memory 410 may be efficiently used even in transmitting the I-key transport data 429.

In addition, after the encrypting process, the I-key encryption unit 422 instructs the transmitter 424 to transmit the I-key transport data 429.

Then, in the next step S703, the transmitter 424 transmits the I-key transport data 429 obtained as a result of the encryption in step S702. Concretely, in the second embodiment, a broadcast address is set as a destination address. Therefore, the communication device communication device 400 broadcasts the I-key transport data 429.

For example, when a plurality of communication devices 400 configure a wireless ad hoc network, a broadcast in step S703 refers to a transmission to all other communication devices 400 in the range reached in one hop. Therefore, the PDU transmitted by the transmitter 424 is a target to be processed in all other communication devices 400 which may directly receive the PDU without a relay.

When a plurality of communication devices 400 configure a cable ad hoc network, a broadcast in step S703 refers to a transmission to all other communication devices 400 in the range reached in one hop. That is, the I-key transport data 429 is transmitted to all other communication devices 400 connected to the source communication device 400 of the I-key transport data 429 directly by cable. Then, the transmitted PDU is a target to be processed in FIG. 17 in all other communication devices 400 connected to the source communication device 400 of the I-key transport data 429 directly by cable.

Otherwise, when the second embodiment is applied to the Ethernet (registered trademark), the I-key transport data 429 is transmitted to all communication devices 400 belonging to the same broadcast domain as the source communication device 400 of the I-key transport data 429. Then, the transmitted PDU is a target to be processed in FIG. 17 in all communication devices 400 belonging to the same broadcast domain as the source communication device 400.

Anyway, after the broadcast in step S703, control is returned to step S701.

According to FIG. 19, the payload of the I-key transport data 429 is encrypted each time the notification of the internally-originated access key is issued, but the I-key transport data 429 is reused depending on the embodiments. That is, when the update interval AI and the notification interval AN of the internally-originated access key are set so that the same internally-originated access key may be reported plural times, the I-key transport data 429 may be generated only when a first notification of the internally-originated access key is issued.

Then, until the internally-originated access key is next updated, the memory 410 may continuously hold the I-key transport data 429 whose payload is encrypted. Then, in the second and subsequent notifications after the update of the internally-originated access key, the process in step S702 may be omitted. That is, the I-key management unit 403 may instruct the transmitter 424 to re-transmit the existing I-key transport data 429 on the memory 410. Next, the executing timing of various processes described above is described with reference to FIG. 20. FIG. 20 is a timing chart of updating a shared key and an internally-originated access key according to the second embodiment.

In the second embodiment, the shared key management unit 402 periodically updates a shared key at a specified update interval SI. FIG. 20 illustrates the shared key SK_{γ-1} of the (γ−1)-th generation to the shared key SK_{γ+2} of the (γ+1)-th generation.

In addition, as described above with reference to step S508 in FIG. 17, the re-encryption performed when the decryption by the current shared key fails and the decryption by the old shared key are performed only at a specified allowed time ST from the update of the shared key in the second embodiment. Then, the allowed time ST is shorter than the update interval SI.

It is preferable that, for example, the update interval SI is set to an appropriate value depending on the traffic amount in the network including the communication device 400. As an example, the update interval SI may be 6 through 12 hours. It is also preferable that the allowed time ST is set to an appropriate value depending on the embodiments based on the accuracy of synchronization among the communication devices 400, the time taken for the communication between the communication devices 400 which transport an access key, etc.

Then, independent of the update of the shared key by the shared key management unit 402, the I-key management unit 403 periodically updates the internally-originated access key at a specified update interval AI. FIG. 20 illustrates the internally-originated access key AK_{A,a-1} of the (a−1)-th generation through the internally-originated access key AK_{A,a+}4 of the (a+4)-th generation,

The update interval AI of the internally-originated access key is shorter than the update interval SI of the shared key, and it is preferable that the update interval AI is less than half of the update interval SI of the shared key. It is preferable that the update interval AI of the internally-originated access key is, for example, set to an appropriate value depending on the traffic amount in the network including the communication device 400. As an example, the update interval AI of the internally-originated access key may be about 10 through 20 minutes. The length of the update interval SI of the shared key may be some length not divisible by the update interval AI of the internally-originated access key.

Also in the second embodiment, as described above with reference to step S606 in FIG. 18, the re-encryption performed when the decryption using the current internally-originated access key fails and the decryption by the old internally-originated access key are performed only in the period from the update of the internally-originated access key to the specified allowed time AT. The allowed time AT is shorter than the update interval AI. It is preferable that the allowed time AT is set to an appropriate value depending on the embodiments based on, for example, the time taken for a communication between the communication devices 400 communicating the encrypted PDU using an access key.

Furthermore, according to the second embodiment, as described above with reference to step S701 in FIG. 19, the communication device 400 notifies another communication device 400 of the internally-originated access key at a specified notification interval AN. The notification interval AN is shorter than the update interval AI of the internally-originated access key, and preferably half or less of the update interval AI. As an example, the notification interval AN may be about 1 through 5 minutes. The length of the update interval AI may be some length not divisible by the notification interval AN.

Since the notification interval AN is shorter than the update interval AI, for example, the internally-originated access key AK_{A,a} of the a-th generation is reported five times in the period in which the internally-originated access key AK_{A,a} is recognized as the current internally-originated access key. Thus, it is preferable especially for the communication device 400 in the ad hoc network to issue a notification of the internally-originated access key more frequently than to update the internally-originated access key.

It is because the communication device connected to the ad hoc network may be dynamically changed from time to time. For example, a new communication device 400 may enter the ad hoc network at an arbitrary time point.

To be more concrete, for example, the new communication device 400 which has not been connected to the ad hoc network at the time point of the first notification of the access key AK_{A,a}, may be connected to the ad hoc network at the third notification time point of the access key AK_{A,a}. Then, the communication device 400 which has newly entered the ad hoc network may start an encrypted communication using an access key immediately after the third notification time point of the access key AK_{A,a} without waiting for the notification of the access key AK_{A,a+1} of the next (a+1)-th generation.

In addition, the setting position of the communication device 400 may be fixed, but the communication device 400 may be a mobile in a wireless ad hoc network. Then, with the transport of the communication device 400, or with a change of the wireless communication environment such as the presence/absence of a shield etc., there may be a case where an access key is not received accidentally.

For example, the communication device 400 of the address Adr_{B} may fail to receive the first notification of the access key AK_{A,a} from the communication device 400 of the address Adr_{A}. However, depending on the change of the wireless communication environment, the communication device 400 of the address Adr_{B} may successfully receive the second notification of the access key AK_{A,a} from the communication device 400. Then, the communication device 400 of the address Adr_{B} is enabled to encrypt the PDU addressed to the communication device 400 of the address Adr_{A} using the access key AK_{A,a} and to transmit the encrypted PDU at and subsequent to the second notification of the access key AK_{A,a}.

Therefore, after the communication device 400 of the address Adr_{A} updates the access key from the (a−1)-th generation to the a-th generation, the device receives the PDU encrypted by the old access key AK_{A,a-1} from the communication device 400 of the address Adr_{B} until a little after the second notification. Then, for example, assume that the range of the allowed time AT includes the period until a little after the second notification of the access key AK_{A,a} as illustrated in FIG. 20. Then, for the communication device 400 of the address Adr_{A}, the PDU encrypted by the access key AK_{A,a-1} is received in the valid period of the old internally-originated access key AK_{A,a-1}. Therefore, the transmission and reception of the PDU encrypted by the access key AK_{A,a-1} is not wasted, and the error processing such as a re-request of the PDU etc. is not necessary.

That is, as known by the example above, it is preferable that not only the notification interval AN is shorter than the update interval AI, but also it is half or less of the allowed time AT. The reason is supplemented below.

If the notification interval AN is half or less of the allowed time AT, then a plurality of notifications are included in the allowed time AT. Accordingly, there is a probable expectation that the destination communication device 400 may recognize a new access key after the update within the allowed time AT even when the first notification after the update of the access key is incidentally unreceivable by the communication device 400 at the destination. Then, the frequency of the error processing is reduced. In addition, if the notification interval AN is short, the frequency of the re-encryption and the decryption by the old internally-originated access key is reduced. Then, as a result, the process load of the re-encryption and the re-decryption on each communication device 400 is also reduced, thereby reducing the wasteful traffic in the network.

The present invention is not limited to the above-mentioned embodiments. Some variations are described above, but the embodiments above may be further varied from the following aspects 1 through 7. The variations above and below may be arbitrarily combined unless they are inconsistent to one another.

The first aspect relates to the update interval and the notification interval of a cryptographic key. Depending on the embodiments, the notification interval AN of the access key may be the same as the update interval AI of the access key. That is, each time the internally-originated access key is generated, the internally-originated access key may be notified once immediately after the generation. For example, in the cable network of excellent communication quality, the notification interval AN may be the same as the update interval AI.

Furthermore, the valid period may be set in only one of the shared key and the access key. That is, in the second embodiment, the branch relating to the valid period may be omitted in step S508 in FIG. 17 or step S606 in FIG. 18. On the other hand, in the first embodiment, the valid period as in the second embodiment may be introduced. Omitting the valid period is setting a valid period equal to the update interval of the cryptographic key.

When a plurality of communication devices generate and update the cryptographic key according to the same algorithm, the update timing of the cryptographic key is decided in advance so that a plurality of communication devices may have shared recognition relating to the update timing of the cryptographic key. The update at a fixed interval is a method for a plurality of communication devices having shared recognition relating to the update timing of the cryptographic key. Obviously, depending on the embodiments, the schedule at an irregular interval relating to the update timing of the cryptographic key may be shared among a plurality of communication devices.

On the other hand, relating to the cryptographic key established between the communication devices by key transport, the interval at which a communication device updates the cryptographic key is allowed to be unfixed. For example, the communication devices 400 according to the second embodiment transport their access keys to each other. Therefore, it is possible for each individual communication device 400 not to recognize in advance the timing when another communication device 400 updates its access key.

For example, when there are the first and second communication devices 400, it is not necessary to for the second communication device 400 to know the interval of the update of the internally-originated access key for the first communication device 400. Therefore, the first communication device 400 may dynamically change the update interval of the internally-originated access key depending on the change of the state such as the reception frequency of the PDU.

The second aspect relates to the number of stored cryptographic keys. The key storage unit 102 according to the first embodiment may hold the old keys in two or more generations. Similarly, the shared key storage unit 406 according to the second embodiment may hold the old shared keys in two or more generations, and the I-key storage unit 407 may hold the old internally-originated access keys in two or more generations. Then, the re-encryption and decryption may be sequentially attempted as necessary on a plurality of old cryptographic keys held in the device.

For example, the key storage unit 102 may hold cryptographic keys of three generations, that is, a current key, an old key of one generation before, and an old key of two generations before. When a new cryptographic key is generated, the key management unit 101 appropriately updates the cryptographic keys of three generations on the key storage unit 102. In this case, in decryption of the payload of the received PDU, it is appropriate that the communication device 100 sequentially attempts the cryptographic keys from the newest, that is, the current key, the old key of one generation before, and the old key of two generations before in this order.

Concretely, if the two feature values do not match each other in step S111 in FIG. 7, the judgment unit 107 instructs the re-encryption unit 108 to re-encrypt the payload of the received data 114. In this case, the selected cryptographic key is not reset at the stage of step S111.

Then, the re-encryption unit 108 re-encrypts the payload of the received data 114 by the old key of one generation before. Furthermore, the re-encryption unit 108 notifies the directive unit 103 of the completion of the re-encryption. Then, the directive unit 103 switches the selected cryptographic key from the old key of one generation before which is currently selected to the old key of two generations before.

Then, the directive unit 103 instructs the decryption unit 106 to decrypt the payload of the received data 114. Then, the decryption unit 106 decrypts the payload of the received data 114 using the old key of two generations before. Furthermore, the decryption unit 106 notifies the judgment unit 107 of the completion of the decryption.

Then, the judgment unit 107 retrieves the feature value from the decrypted payload, calculates the feature value from the body, and compares the two feature values. As a result, if the two feature values match each other, the selected cryptographic key is reset, and control is passed to step S106. On the other hand, if the two feature values do not match each other, the selected cryptographic key is reset, and control is passed to step S112.

Obviously, the second embodiment may be varied as described above. Furthermore, the embodiment of further using the old key of three or more generation before may be used. As described above, the embodiment using the old key of two or more generation before is especially preferable for the encrypted communication between the communication devices which take a long communication time.

The third aspect relates to the range in which a cryptographic key is established. The range in which a cryptographic key is established may be appropriate changed depending on the embodiments.

For example, when the communication device 400 in FIG. 14 is used as a node in the ad hoc network 140 in FIG. 2, the same shared key may be used among all nodes of the ad hoc network 140. However, depending on the configuration of a network, the layer of the protocol to be applied, the purpose of the encrypted communication, etc., the range of establishing the cryptographic key may be appropriately varied.

For example, according to the second embodiment, in step S703 in FIG. 19, the internally-originated access key is reported to all other communication devices 400 in one hop by broadcast. However, depending on the embodiments, the destination communication device 400 of the internally-originated access key may be limited to, for example, a specific one.

The fourth aspect relates to the generation algorithm of an cryptographic key. The generation algorithm of a cryptographic key is arbitrary. That is, the key management unit 101, the shared key management unit 402, and the I-key management unit 403 may generate a cryptographic key according to the arbitrary algorithm.

For example, the key management unit 101, the shared key management unit 402, and the I-key management unit 403 may generate a cryptographic key by performing a process of obtaining a unique value for time. The process of obtaining a unique value for time is to generate a cryptographic key using a random number by generating a random number using the current time as a seed. The seed may be information obtained by combining the information identifying a communication device (for example, ID or an address) with the current time.

The fifth aspect may be, for example, a hash value as the feature value 303 in FIG. 6. In this case, the encrypted feature value 306 corresponds to the keyed-Hashing for MAC (HMAC) as a type of message authentication code (MAC).

In the first and second embodiments, the body 301 and the feature value 303 are encrypted by the same encryption algorithm using the same cryptographic key. However, the body 301 and the feature value 303 may be encrypted using different cryptographic keys, and the feature value 303 and the feature value 303 may be encrypted according to different encryption algorithms.

For example, in the second embodiment, the part of the body 301 in the payload is encrypted by the access key relating to the PDU of the type which may be encrypted by an access key, and the part of the feature value 303 may be encrypted by a fixed cryptographic key. In this case, the received data decryption unit 413 may decrypt the encrypted body by the internally-originated access key, and the encrypted feature value may be decrypted by a fixed cryptographic key. Furthermore, the received data re-encryption unit 420 may re-encrypt the decrypted body by the internally-originated access key, and the decrypted feature value may be re-encrypted by a fixed cryptographic key.

Depending on the embodiments, a digital signature may be used by a public key encryption algorithm may be used for judgment by the judgment unit 107, the E-key judging unit 416, or the received data judging unit 417.

For example, For example, the first communication device 400 publishes the public key to the second communication device 400 in advance. Then, the data processing unit 423 of the first communication device 400 calculates a hash value from the body 301, and encrypts the calculated hash value using a secret key, thereby generating the digital signature as the feature value 303. In this case, the transmission data encryption unit 421 may encrypt the entire payload including the digital signature by the access key of the second communication device 400, or may encrypt only a part of the body 301 by the access key of the second communication device 400.

In the embodiment in which the transmission data encryption unit 421 encrypts the entire payload including the digital signature as the feature value 303 by the access key of the second communication device 400, the received data decryption unit 413 of the second communication device 400 decrypts the entire payload by the access key. Then, the received data judging unit 417 decrypts the decrypted feature value 309 by a public key and obtains a hash value. The received data judging unit 417 calculates a hash value corresponding to the feature value 311 in FIG. 6.

If the two obtained hash values are equal, the received data judging unit 417 judges that the payload has been decrypted by the same access key that is used in the encryption. That is, the received data judging unit 417 judges that the decrypted data is valid plaintext data, and the decryption has been successfully performed.

On the other hand, when the two hash values are different from each other, the received data judging unit 417 judges that the payload has been decrypted by a different access key from the key used in the encryption. That is, the received data judging unit 417 judges that the decrypted data is invalid, and the decryption has failed.

That is, according to the first and second embodiments, whether or not the decrypted feature value 309 completely matches the calculated feature value 311 is used in judging the consistency between the decrypted feature value 309 and the calculated feature value 311. However, as described above, depending on the embodiments, the result obtained by performing an operation such as decryption etc. by a public key on the decrypted feature value 309 is compared with the feature value 311. That is, depending on the embodiments, the judgment of the consistency is made based on the reference other than the reference as to whether or not the decrypted feature value 309 itself completely matches with the feature value 311.

When the digital signature is used, the transmission data encryption unit 421 of the first communication device 400 may encrypt only the part of the body 301 by the access key of the second communication device 400. In this case, the received data decryption unit 413 of the second communication device 400 decrypts only the decrypted body 305 by the access key.

Then, the received data judging unit 417 obtains a hash value by decrypting the digital signature as the feature value 303 by a public key. The received data judging unit 417 calculates the hash value corresponding to the feature value 311 in FIG. 6 from the decrypted body 308. Then, the received data judging unit 417 judges the consistency between the feature value 303 and the calculated feature value 311 by comparing the two hash values.

The sixth aspect relates to a data format. The data is exemplified in the table format in FIGS. 5 and 15, but the format of the data held in the key storage unit 102, the key recognition unit 112, the shared key storage unit 406, the I-key storage unit 407, and the E-key storage unit 408 is not limited to the table format.

For example, the key storage unit 102 may be realized by a ring buffer of the size of 3. Then, in the ring buffer, one entry may be used for a current key, one entry may be used for an old key, and one entry may be used for a temporary storage area of a newly generated cryptographic key. In this case, the key management unit 101 may operate the pointer to the current key each time the cryptographic key is generated. Similarly, the I-key storage unit 407 may be realized by the ring buffer.

In addition, the data format in the key recognition unit 112 and the E-key storage unit 408 may be in the table format as illustrated, and may be a linear list or a first-in-first-out (FIFO) queue in which an address and a cryptographic key pair are included as elements.

The seventh aspect related a target of overwrite. The second embodiment may be modified so as to omit overwrite of a storage area for the PDU for transport of an access key. That is, the I-key encryption unit 422, the E-key decryption unit 414, and the E-key re-encryption unit 419 do not necessarily overwrite the storage area in the encryption or the decryption.

The reason is that the PDU for control such as a PDU for transporting an access key etc. has generally a short payload. Therefore, the influence of the consumption of the storage area by not overwriting the storage area is lower in the case of the PDU for transporting an access key than in the case of the PDU for application data, which is encrypted by an access key. That is, depending on the embodiments, the effective use of the memory 410 may be attained only by overwriting the storage area for the PDU for application data which is encrypted by an access key.

For the similar reason, for example, in specific environments such as a lower transmission frequency than the reception frequency, a greater data length of the transmission data 115, etc., it is not necessary to overwrite the storage area for the transmission data 115.

In the description of the present specification above, the meaning of the term “overwrite” includes “write back”. For example, overwriting the first data directly with the second data refers to, from another viewpoint, writing back the second data to the storage area in which the first data is stored. Furthermore, “overwrite” also refers to writing back the second data to the same storage area after clearing the start in which the first data is stored.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device comprising:
a data storage unit that stores apiece of encrypted data or a piece of decrypted data;
a decryption unit that decrypts each provided piece of encrypted data;
an encryption unit that encrypts each provided piece of decrypted data;
a judgment unit that issues an instruction to the encryption unit
to read from the data storage unit first decrypted data obtained by the decryption unit decrypting first encrypted data with a cryptographic key, and
to write back to the data storage unit second encrypted data obtained by the encryption unit encrypting the first decrypted data with the cryptographic key.

2. The communication device according to claim 1, wherein the decryption unit reads the second encrypted data from the data storage unit, and writes back to the data storage unit second decrypted data obtained by decrypting the second encrypted data with another cryptographic key different from the cryptographic key.

3. The communication device according to claim 1, further comprising:
a key storage unit that includes
a first storage area to store the cryptographic key and
a second storage area to store another cryptographic key different from the cryptographic key; and
a key management unit that
stores a new cryptographic key in a third storage area,
copies the cryptographic key stored in the first storage area to a fourth storage area,
copies the new cryptographic key from the third storage area to the first storage area after copying the cryptographic key from the first storage area to the fourth storage area, and
copies the cryptographic key copied to the fourth storage area to the second storage area after copying the new cryptographic key from the third storage area to the first storage area.

4. The communication device according to claim 1, further comprising:
a key management unit that repeats update of the cryptographic key;
a notification unit that notifies another communication device of the cryptographic key updated by the key management unit, at an interval of half or less than an update interval at which the key management unit updates the cryptographic key.

5. The communication device according to claim 1, further comprising:
a key management unit that updates the cryptographic key; and
a notification unit that repeatedly issues a notification for notifying another communication device of the cryptographic key updated by the key management unit, wherein:
the judgment unit issues the instruction to the encryption unit only within a period from when the key management unit updates the cryptographic key to when a specified allowable time passes; and
a notification interval at which the notification unit issues the notification is half or less than a length of the allowable time.

6. A computer-readable recording medium having stored therein a program for causing a computer to execute a process comprising:
storing first encrypted data in a data storage unit provided in the computer;
obtaining decrypted data by decrypting the stored first encrypted data with a cryptographic key;
storing the obtained decrypted data in the data storage unit;
reading the stored decrypted data from the data storage unit;
obtaining second encrypted data by encrypting the read decrypted data with the cryptographic key; and
writing back the obtained second encrypted data to the data storage unit.

7. A method executed by a communication device, the method comprising:
storing first encrypted data in a data storage unit provided in the communication device;
obtaining decrypted data by decrypting the stored first encrypted data with a cryptographic key;
storing the obtained decrypted data in the data storage unit;
reading the stored decrypted data from the data storage unit;
obtaining second encrypted data by encrypting the read decrypted data with the cryptographic key; and
writing back the obtained second encrypted data to the data storage unit.
